(19) United States
(12) Patent Application Publication
(10) Pub. No.: US 2025/0186875 A1
(43) Pub. Date: Jun. 12, 2025

(54) DECELERATION MECHANISM

(71) Applicant: JAPAN CASH MACHINE CO., LTD., Osaka (JP)

(72) Inventor: Shigenori Matsushita, Osaka (JP)

(73) Assignee: JAPAN CASH MACHINE CO., LTD., Osaka (JP)

(21) Appl. No.: 18/846,100

(22) PCT Filed: Jan. 26, 2023
(86) PCT No.: PCT/JP2023/002496

§ 371 Date: Sep. 11, 2024

(30) Foreign Application Priority Data
Mar. 31, 2022 (JP) 2022-058808

(51) Int. Cl. A63F 7/02; H02K 49/02

(52) U.S. Cl. CPC A63F 7/022; H02K 49/02

(57) ABSTRACT

A moving body and a transport body are decelerated in a deceleration section by a deceleration mechanism. The deceleration mechanism includes a moving body that has moving body magnets and that moves on an air flow path while receiving an air flow, a transport body that has a magnetic material (transport body magnets or a transport body magnetic material repelling or attracting the moving body magnets and that is transported on a transport path in conjunction with the moving body on the basis of a magnetic force acting between the moving body magnets and the magnetic material, and braking means that is arranged in a deceleration section on the air flow path and that decelerates the moving body. The braking means includes an electric conductor in which an eddy current is generated due to movement of the moving body magnets.

### FIELD

The present invention relates to a deceleration mechanism.

### BACKGROUND

In a game hall where various types of game machines such as pachinko machines, pachislot (pachinko-slot) machines, or slot machines are installed, game media dispensing devices for renting pachinko balls or tokens being game media to players according to the money amount of banknotes input through a banknote inlet are placed adjacent to the game machines. Various banknote transport devices (intra-bank banknote transport-related devices) are developed and installed as bank facilities to enable the game media dispensing devices to safely and smoothly collect and transport banknotes received by each of the game media dispensing devices to a cashbox.

A bank-end cashbox unit for storing and managing transported banknotes in the cashbox under secure management is installed at an end portion of each of the banknote transport devices. Development of a system for transporting collected banknotes to a cashbox without human intervention has been demanded also in game facilities, such as a casino, that handle a large amount of banknotes with the objective of preventing fraudulent acts by involved persons.

Patent Literature 1 discloses that a banknote transport device enabling a moving body to travel in an air blowing tube using an air flow and enabling a banknote transport body to travel using a magnetic force in conjunction with movement of the moving body is installed in each of bank facilities in a game hall. Since no mechanical driving means such as a motor, a gear, and a transport belt are required to cause the moving body and the transport body to travel, the durability of members constituting the transport mechanism can be increased and the running cost of the transport device can be reduced.

Patent Literature 2 discloses a transferring device including a transport tube, a moving body that has a magnet sliding inside the transport tube, an air blower that transfers the moving body, and a transported body that has a magnet attracting the magnet of the moving body and that slides on a lateral surface of the transport tube.

Patent Literature 1 describes that the speed of the moving body can be controlled by the air volume of a blower. This literature also describes that an endless circular air blowing tube and an endless circular circulation pipe are connected in a figure eight manner via a flow path switching valve. A blower that generates an air flow flowing in a certain direction is connected to the circulation pipe. This banknote transport device can adjust the air volume and the direction of an air flow in the air blowing tube by controlling the flow path switching valve without controlling the blower.

### CITATION LIST

### Patent Literatures

Patent Literature 1: Japanese Patent Application Laid-open No. 2020-192241
Patent Literature 2: Japanese Patent Application Laid-open No. S47-44782

### SUMMARY

### Technical Problem

Assuming that the air flow path of the banknote transport device of Patent Literature 1 includes many deceleration sections in which the speed of the moving body should be decreased. In this case, if the speed of the air flow is adjusted by controlling the blower or the flow path switching valve each time the moving body reaches each of the deceleration sections, there is a risk that many sensors that detect the position of the moving body are required and that control of the blower and the flow path switching valve is complicated.

Patent Literature 2 does not describe a method for decelerating the moving body and the transported body.

The present invention has been made in view of circumstances described above, and an object of the present invention is to enable traveling bodies such as a moving body and a transport body to be decelerated in a specific section with a simple configuration.

### Solution to Problem

In order to solve the above problem, the present invention comprises: a traveling body that travels on a predetermined route; and braking means that decelerates the traveling body in a deceleration section set in the route, wherein the traveling body or the braking means includes an electric conductor, and the braking means or the traveling body includes a magnet that generates an eddy current in the electric conductor.

### Advantageous Effects of Invention

According to the present invention, a traveling body can be decelerated in a deceleration section with a simple configuration.

### BRIEF DESCRIPTION OF DRAWINGS

FIG. 1 is a perspective view illustrating a schematic configuration of bank facilities including a plurality of game machines.

FIG. 2 is a plan view illustrating a schematic configuration of the bank facility including a plurality of the game machines.

FIG. 3 is a schematic diagram illustrating a schematic configuration of a banknote transport system.

FIG. 4 is a vertical sectional view of a moving body, an air blowing tube including the moving body, a transport body, and a transport tube including the transport body in a case in which the moving body and the transport body repel each other due to a magnetic force.

FIGS. 5(a) to 5(c) are schematic diagrams illustrating a relation between an air blowing tube and an air-blow control unit according to one embodiment of a first invention.

FIG. 6 is a perspective view illustrating a relation between the transport tube and the transport body.

FIG. 7 is a vertical sectional view of the air blowing tube and the transport tube including the moving body and the transport body in a case in which the moving body and the transport body attract each other due to a magnetic force.

FIG. 8 is a vertical sectional view of the air blowing tube and the transport tube including the moving body and the transport body in a case in which the poles of each of moving body magnets are arranged to face in a travel direction.

FIG. 9 is a diagram illustrating a first modification of the air-blow control unit.

FIG. 10 is a diagram illustrating a second modification of the air-blow control unit.

FIGS. 11(a) and 11(b) are schematic diagrams for explaining a basic configuration of a deceleration mechanism according to one embodiment of the present invention.

FIGS. 12(a) to 12(c) are schematic diagrams for explaining the deceleration principle of the deceleration mechanism.

FIGS. 13(a) to 13(c) are schematic diagrams for explaining setting examples of the deceleration section.

FIG. 14(d) is a schematic diagram for explaining a setting example of the deceleration section.

FIGS. 15(a) and 15(b) are schematic diagrams illustrating examples of a method of switching the electromagnetic induction effect in the deceleration mechanism on and off.

FIGS. 16(a) and 16(b) are schematic diagrams illustrating a transport system according to a first embodiment of a second invention.

FIG. 17 is a schematic diagram illustrating a transport system according to a second embodiment of the second invention.

FIG. 18 is a schematic diagram illustrating a transport system according to a third embodiment of the second invention.

FIGS. 19(a) and 19(b) are schematic diagrams illustrating a transport system according to a fourth embodiment of the second invention.

FIGS. 20(a) to 20(c) are schematic diagrams illustrating a transport system according to a fifth embodiment of the second invention.

FIGS. 21(a) to 21(c) are schematic diagrams illustrating a transport system according to a sixth embodiment of the second invention.

### DESCRIPTION OF EMBODIMENTS

The present invention will be described below in detail with embodiments illustrated in the drawings. Constituent elements, types, combinations, shapes, and relative arrangements described in the following embodiment are merely explanatory examples, and are not intended to limit the scope of the present invention solely thereto unless otherwise specified. Configurations described in the following embodiments can be combined with each other as appropriate in a range without any mutual contradiction.

Embodiments of the present invention are described below in detail.

### A. Paper Sheet Transport System According to First Invention

A basic configuration and an operation of a paper sheet transport system according to a first invention are explained below.

The paper sheet transport system is installed on each of bank facilities in a game hall where various types of game machines such as pachinko machines or pachislot (pachinko-slot) machines are installed. Although banknotes are mainly explained as an example of paper sheets in the following embodiment, the present invention is also applicable to paper sheets (sheets) other than the banknotes, including securities such as cash vouchers or gift certificates, cards, and the like.

Although not particularly illustrated or explained, the paper sheet transport system according to the present invention is also applied to a banknote transport system or a banknote transport device in casinos.

### [Schematic Configuration of Bank Facilities]

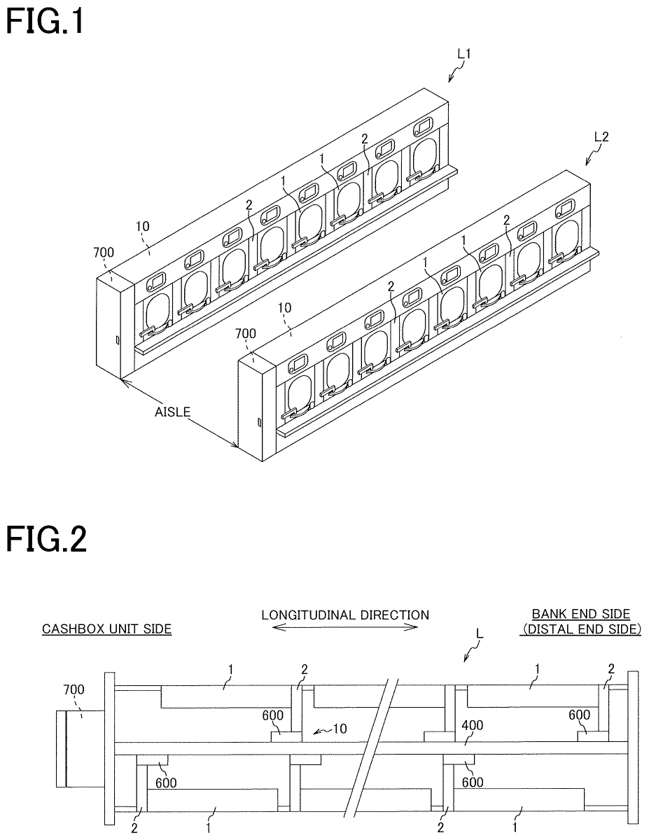

FIG. 1 is a perspective view illustrating a schematic configuration of bank facilities including a plurality of game machines.

Game machines 1 are installed on bank facilities L (L1, L2, . . . ) and eight game machines 1 are arranged back to back on each of two opposing side surfaces of each of the bank facilities L, that is, a total of 16 game machines 1 are arranged back to back. An aisle on which players or clerks of the game hall walk is provided between the bank facilities L and a chair (not illustrated) is provided for each of the game machines 1 on the aisles.

A sandwiched machine 2 is installed for each of the game machines 1 on the bank facilities L. The sandwiched machine 2 includes a banknote inlet (a banknote input part) that receives input banknotes, a game media dispensing device that dispenses a number of pachinko balls corresponding to the money amount of input banknotes, and the like. A banknote transport system 10 that transports banknotes inserted through the sandwiched machines 2 to a cashbox unit 700 placed at one end portion of the associated bank facility L is installed in each of the bank facilities L illustrated in FIG. 1.

FIG. 2 is a plan view illustrating a schematic configuration of the bank facility including a plurality of the game machines.

The banknote transport system 10 installed in each of the bank facilities L includes receiving units (banknote receiving devices) 600 that each receive banknotes inserted from the banknote inlet of the associated sandwiched machine 2 therein, a transport tube 400 that extends in a longitudinal direction of the bank facility L (an array direction of the game machines 1) and that transports the banknotes received by the receiving units 600, the cashbox unit 700 that is arranged at one end of the transport tube 400, and the like.

### [Schematic Configuration of Banknote Transport System]

### <Overall Outline>

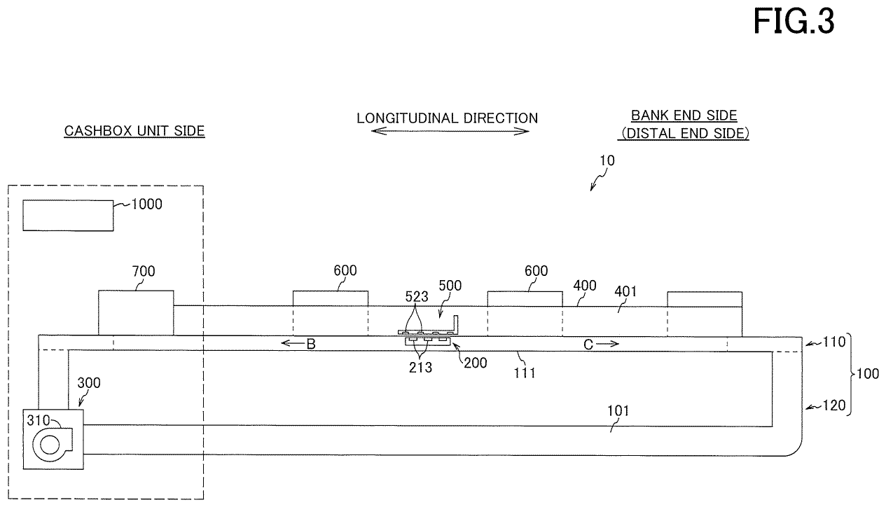

FIG. 3 is a schematic diagram illustrating a schematic configuration of the banknote transport system. The banknote transport system (paper sheet transport mechanism) 10 according to one embodiment of the first invention is characterized in transporting banknotes using an air flow and a magnetic force.

The banknote transport system 10 includes an air blowing tube 100 that forms a flow path (an air flow path 101) of a gas, a moving body 200 that travels (moves) inside the air blowing tube 100 while receiving an air flow flowing in a predetermined direction within the air blowing tube 100, an air-blow control unit 300 that controls the air flow flowing inside the air blowing tube 100, the transport tube 400 (a transport path 401) that has at least a portion arranged along the air blowing tube 100 to be adjacent to the air blowing tube 100, and a transport body 500 that is configured to be able to retain banknotes (paper sheets) and that travels (moves) inside the transport tube 400. The transport tube 400 forms the transport path 401 (a banknote (paper sheet) transport route and a transport space) for banknotes.

The moving body 200 includes a moving body magnetic material (moving body magnets 213), and the transport body 500 includes a transport body magnetic material (transport body magnets 523). At least one of the moving body magnetic material and the transport body magnetic material is formed of a magnet.

The banknote transport system 10 includes the receiving units 600 that receive banknotes input from outside and keep the banknotes at predetermined locations in the transport tube 400, respectively, the cashbox unit 700 that includes a banknote accommodating part that accommodates therein banknotes transported by the transport body 500, and a management unit (control means) 1000 that controls the components constituting the banknote transport system 10.

In the present example, the air-blow control unit 300 and the cashbox unit 700 are accommodated in a housing 1001 that has the management unit 1000 housed therein.

The banknote transport system 10 is characterized in moving the moving body 200 arranged in the air blowing tube 100 back and forth in the longitudinal direction of the air blowing tube 100 with the air flow flowing inside the air blowing tube 100, and in moving the transport body 500 arranged in the transport tube 400 along the longitudinal direction of the air blowing tube 100 with a magnetic force acting between the transport body 500 and the moving body 200. That is, the banknote transport system 10 is characterized in moving the transport body 500 in conjunction with movement of the moving body 200 receiving the air flow due to attraction and/or repulsion based on a magnetic force acting between the moving body magnets 213 and the transport body magnets 523.

### <Outline of Components>

The air blowing tube 100 includes a moving route part 111 in at least a portion in the longitudinal direction, on which the moving body 200 travels along the longitudinal direction of the air blowing tube 100. The moving route part 111 is arranged in parallel and adjacently to the transport tube 400.

The moving body 200 moves inside the air blowing tube 100 while receiving an air flow flowing in a predetermined direction within the air blowing tube 100. The moving body magnets 213 mounted on the moving body 200 provide a repelling action and/or an attracting action due to a magnetic force to the transport body 500. The moving body 200 moves the moving body 200 in conjunction with its own movement due to the magnetic force.

The air-blow control unit 300 includes a blower (an air flow generating device) 310 that generates (produces) an air flow in a predetermined direction inside the air blowing tube 100 and that can change the flow volume and the flow speed of the air flow. The air-blow control unit 300 alternately generates an air flow in a first direction (a banknote collecting direction and an arrow-B direction) and an air flow in a second direction (a transport body returning direction and an arrow-C direction) being an opposite direction to the first direction inside the air blowing tube 100 to reciprocate the moving body 200 inside the air blowing tube 100.

The transport tube 400 forms a space through which banknotes and the transport body 500 move.

The transport body 500 receives the banknotes kept at the predetermined locations in the transport path 401 to retain the banknotes in an upright state, and moves inside the transport path 401 to transport the banknotes to the cashbox unit 700. The transport body magnets 523 mounted on the transport body 500 are subjected to the attracting action and/or the repelling action due to the magnetic force from the moving body magnets 213 included in the moving body 200. The transport body 500 moves inside the transport tube 400 in conjunction with the movement of the moving body 200 receiving the air flow.

When only the attracting force is to be applied between the moving body 200 and the transport body 500, both the magnetic materials mounted on the moving body 200 and the transport body 500 can be magnets, or one of the magnetic materials of the moving body 200 and the transport body 500 may be magnets and the other one may be a magnetic material such as iron. When only the repelling force is to be applied between the moving body 200 and the transport body 500, both the magnetic materials mounted on the moving body 200 and the transport body 500 are formed of magnets.

The receiving unit (banknote receiving device) 600 receives banknotes inserted from the banknote inlet (a banknote inserting part) of the associated sandwiched machine 2 therein and keeps the banknotes at a predetermined location in the transport path 401. The receiving unit 600 is provided for each of the sandwiched machines 2. A plurality of the receiving units 600 are installed in the longitudinal direction of the transport tube 400 at a predetermined interval.

The cashbox unit 700 includes a banknote accommodating part that accommodates therein banknotes transported by the transport body 500, a drive mechanism that drives members related to accommodation of the banknotes in the banknote accommodating part, and the like.

The management unit (control means) 1000 controls operations of the components constituting the banknote transport system 10. The management unit 1000 is configured to include a general computer device that includes a CPU (Central Processing Unit), a ROM (Read Only Memory), a RAM (Random Access Memory), and the like and in which these units are connected via a bus. The CPU is an arithmetic unit that controls the entire banknote transport system 10. The ROM is a nonvolatile memory that has a control program to be executed by the CPU, data, and the like stored therein. The RAM is a volatile memory to be used as a work area for the CPU. The CPU reads the control program stored in the ROM to load the control program into the RAM and execute the control program, so that various functions are realized.

### [Detailed Configuration of Banknote Transport System]

Detailed configurations of the components of the banknote transport system according to the embodiment of the first invention are explained.

### <Air Blowing Tube>

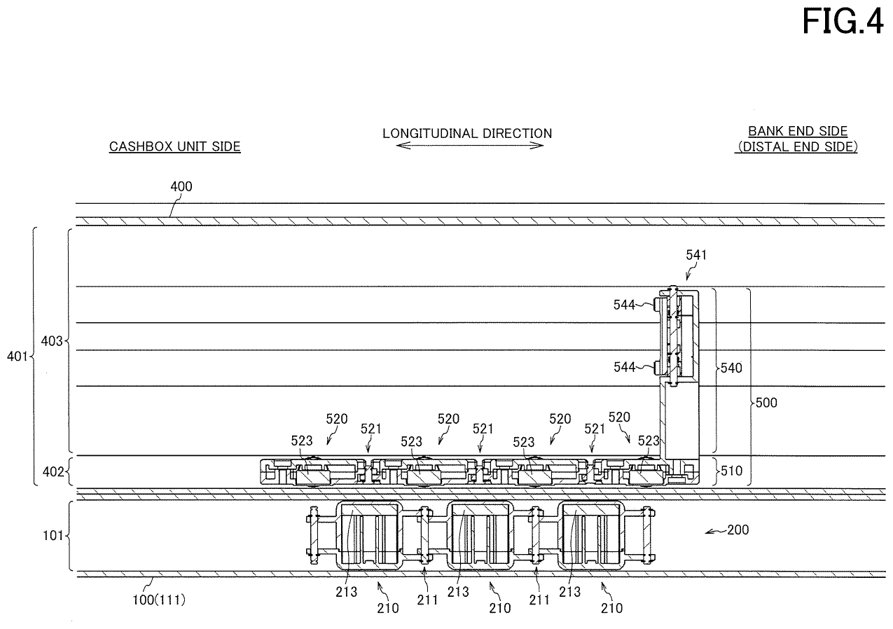

The air blowing tube is explained with reference to FIGS. 3 and 4.

FIG. 4 is a vertical sectional view of the moving body, the air blowing tube including the moving body, the transport body, and the transport tube including the transport body in a case in which the moving body and the transport body repel each other due to a magnetic force.

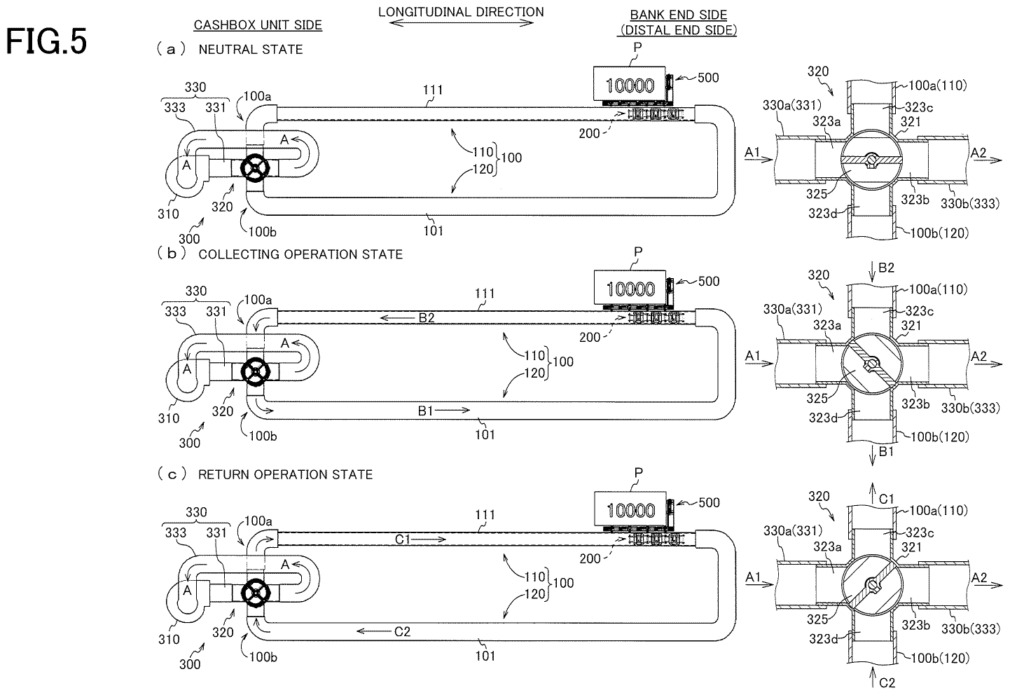

The air blowing tube 100 illustrated in FIG. 3 includes a first air blowing tube 110 including the moving route part 111, and a second air blowing tube 120 forming the air flow path 101 in an endless manner with the first air blowing tube 110 through a switching valve 325 (see FIG. 5), which will be described later.

Since the banknote transport system 10 moves the transport body 500 using a magnetic force, the moving route part 111 of the air blowing tube 100 includes a configuration that does not affect the travel of the moving body 200 and the travel of the transport body 500 based on the magnetic force. While it is desirable that the moving route part 111 is entirely formed of a non-magnetic material, the moving route part 111 may include a magnetic material in a portion within a range that does not affect the travel of the moving body 200 and the transport body 500.

The moving route part 111 includes a configuration (the thickness of the tube, the spacing between the tubes, the shape thereof, and the like) that can apply a magnetic force between the moving body 200 arranged inside the moving route part 111 and the transport body 500 arranged inside the transport tube 400.

With the configuration of the air blowing tube 100 separate from and independent of the transport tube 400, an airtight flow path can be formed in the air blowing tube 100. Reduction in the transport force of the moving body 200 due to air leakage to outside of the air blowing tube 100 can be prevented. Furthermore, the blower 310 being relatively inexpensive and outputting low power can be adopted as a blower to be used to generate an air flow and reduction in the cost of the banknote transport system 10 can be realized. The air flow inside the air blowing tube 100 can be reliably controlled even when the air blowing tube 100 is elongated with an increase in the banknote transport distance. Since the moving body 200 is caused to travel with the air flow, the need to arrange a mechanical configuration such as a gear or a transport belt, lines, or electrical contacts inside the air blowing tube 100 is eliminated and the durability of the air blowing tube 100 and the moving body 200 arranged therein is increased. Furthermore, external air does not flow in the air flow path 101 airtightly configured, so that grit and dust in the external air are not drawn therein and the inside of the air flow path 101 can be kept clean.

### <Moving Body>

It suffices that the moving body 200 has a shape and a configuration that enable movement in the air blowing tube 100 by being subjected to an air pressure.

As illustrated in FIG. 4, the moving body 200 has a configuration in which a plurality of divided pieces 210, 210, . . . are sequentially coupled to each other with hinge parts 211 along a travel direction of the moving body 200 (the longitudinal direction of the air blowing tube 100). The divided pieces 210 illustrated in the present example have same configurations and each of the divided pieces 210 has the moving body magnet 213.

The moving body 200 includes the moving body magnets 213 respectively arranged at locations, in attitudes, and in shapes that enable to apply a magnetic force to the transport body 500. In the present example, the moving body magnets 213 are arranged on a side of the moving body 200 nearer the transport tube 400. The moving body magnets 213 included in the moving body 200 are arranged spaced apart from each other in the travel direction of the moving body 200. In the present example, each of the moving body magnets 213 is attached to the associated divided piece 210 in such a manner that the N pole (one of the poles) faces the side of the transport tube 400 (the upper side in FIG. 4) and the S pole (the other pole) faces the lower side in FIG. 4.

The moving body 200 illustrated in the present example is constituted of three divided pieces 210. The divided pieces 210 are coupled to each other to be angularly displaceable within a predetermined range in the upper-lower direction in FIG. 4 and the depth direction of the plane of the paper centering on the hinge parts 211, respectively. With this configuration, the moving body 200 can smoothly move in the air blowing tube 100 while the divided pieces 210 displace even when the air blowing tube 100 forms the air flow path 101 curved in the upper-lower or right-left direction.

### <Relation Between Air Blowing Tube and Moving Body>

The inner surface shape of the moving route part 111 and the outer surface shape (structure) of the moving body 200 are formed in such a manner that the moving body 200 does not relatively rotate on a virtual axis extending along the longitudinal direction of the moving route part 111 with respect to the moving route part 111. For example, the horizontal sectional shape (the shape on a cross section orthogonal to the longitudinal direction) of the moving route part 111 and the horizontal sectional shape of the divided pieces 210 of the moving body 200 are respectively formed into rectangular shapes. With provision of the configuration described above, the attitude of the moving body 200 in the moving route part 111 can be maintained to cause the N pole (one of the poles) of each of the moving body magnets 213 to always face the side of the transport tube 400.

### <Air-Blow Control Unit>

FIGS. 5(a) to 5(c) are schematic diagrams illustrating a relation between the air blowing tube and the air-blow control unit according to one embodiment of the first invention.

The air-blow control unit 300 according to the present embodiment includes a single blower 310 that generates an air flow flowing in a certain direction, and a switching unit 320 (the switching valve 325) that controls the direction of the air flow in the air blowing tube 100. The air-blow control unit 300 is characterized in switching the direction of the air flow in the air blowing tube 100 between the first direction (the banknote collecting direction and the arrow-B direction) and the second direction (the moving body returning direction and the arrow-C direction) opposite to the first direction using the switching unit 320.

The air-blow control unit (an air-flow control device) 300 includes the switching unit (an air flow switching unit) 320 that controls the discharge direction of the air flow, a first circulation pipe 330 that forms an endless air flow path through the switching unit 320, and the blower 310 that is arranged at an appropriate place in the first circulation pipe 330 to generate an air flow flowing in a certain direction inside the first circulation pipe.

The switching unit 320 includes a casing 321 in which four flow paths 323 (a first flow path 323a to a fourth flow path 323d: ports) respectively connecting to external pipes are formed, and the switching valve 325 that is arranged in a joint portion (an intersecting portion) of the four flow paths 323 to switch the communication state among the flow paths 323 and/or the opening degrees at the time of communication. The flow paths 323 are communicated with and connected to an air discharge tube 331, an air intake tube 333, the first air blowing tube 110, and the second air blowing tube 120 that are external pipes, respectively. In the present example, the flow paths 323 are arranged in a cross manner (a radial manner). The switching valve 325 illustrated in the present example is a rotary valve such as a ball valve and the switching valve 325 rotates in the casing 321 by a predetermined angle, whereby the communication states of the flow paths 323 and the opening degrees of the flow paths 323 are switched.

The switching valve 325 is an electric-operated valve and is driven by a motor to control the rotation angle. For example, a stepping motor can be used as the motor. The switching valve 325 is, for example, controlled to have a desired rotation angle by the management unit 1000 that controls the rotation angle of the stepping motor on the basis of a drive pulse. Of course, other methods may be used for driving means for rotating the switching valve 325 and control of the rotation angle of the switching valve 325. For example, a configuration in which a rotary encoder that rotates in conjunction with the switching valve 325, and a sensor that detects the rotation angle of the rotary encoder are mounted on the switching unit 320 and in which the management unit 1000 executes feedback control of the rotation angle of the switching valve 325 may be adopted.

The first circulation pipe 330 includes the air discharge tube 331 that has one end portion (one end portion 330a of the first circulating pipe 330) communicatively connected to the first flow path 323a of the switching unit 320 and the other end portion communicatively connected to the outlet of the blower 310, and the air intake tube 333 that has one end portion communicatively connected to the inlet of the blower 310 and the other end portion (the other end portion 330b of the first circulation pipe 330) communicatively connected to the second flow path 323b of the switching unit 320.

The air blowing tube (the second circulation pipe) 100 has one end portion 100a communicatively connected to the third flow path 323c of the switching unit 320 and the other end portion 100b communicatively connected to the fourth flow path 323d of the switching unit 320, and forms an endless air flow path through the switching unit 320. The air blowing tube 100 reciprocates the moving body 200 placed therein in the arrow-B direction and the arrow-C direction in FIG. 5 with the air flow.

The air blowing tube 100 according to the present example includes the first air blowing tube 110 forming the moving route part 111 of the moving body 200, and the second air blowing tube 120 communicatively connected to the first air blowing tube 110. The first air blowing tube 110 is communicatively connected to the third flow path 323c and the second air blowing tube 120 is communicatively connected to the fourth flow path 323d.

### <<Operation of Switching Unit: Neutral State>>

FIG. 5(a) illustrates a neutral state.

The switching valve 325 is in a neutral position for establishing communication between the first flow path 323a and the second flow path 323b while not establishing communication between the first and second flow paths 323a and 323b and the third and fourth flow paths 323c and 323d.

Accordingly, the air flow circulates in the first circulation pipe 330 in an arrow-A (A1 and A2) direction and no air flow is generated inside the air blowing tube 100. Therefore, the moving body 200 is in a state stopped in the air blowing tube 100.

### <<Operation of Switching Unit: First Communication State>>

FIG. 5(b) illustrates a first state in which an air flow flowing in the first direction (an arrow-B1 or B2 direction) is generated inside the air blowing tube 100. This state is, for example, a banknote collecting operation state for transporting banknotes collected by the transport body 500 to the cashbox unit 700.

The switching valve 325 is in a first communication position for establishing communication between the first flow path 323a and the fourth flow path 323d and establishing communication between the second flow path 323b and the third flow path 323c. At this time, the first flow path 323a and the fourth flow path 323d are not communicated with the second flow path 323b and the third flow path 323c.

The air circulates in an endless manner between the first circulation pipe 330 and the air blowing tube 100. That is, air (in the arrow-A1 direction) discharged from the discharge tube 331 to flow in the first flow path 323a flows in the second air blowing tube 120 from the fourth flow path 323d (in the arrow-B1 direction) due to the switching valve 325. Air flowing in the arrow-B2 direction inside the first air blowing tube 110 to flow in the third flow path 323c flows in the intake tube 333 from the second flow path 323b (in the arrow-A2 direction) due to the switching valve 325, returns to the blower 310, and is discharged again from the discharge tube 331.

### <<Operation of Switching Unit: Second Communication State>>

FIG. 5(c) illustrates a second state in which an air flow flowing in the second direction (an arrow-C1 or C2 direction) is generated inside the air blowing tube 100. This state is, for example, a return operation state for returning the transport body 500 from the side of the cashbox unit 700 (the side of the management unit 1000) to the distal end side of the transport tube 400.

The switching valve 325 is in a second communication position for establishing communication between the first flow path 323a and the third flow path 323c and establishing communication between the second flow path 323b and the fourth flow path 323d. At this time, the first flow path 323a and the third flow path 323c are not communicated with the second flow path 323b and the fourth flow path 323d.

The air circulates in an endless manner between the first circulation pipe 330 and the air blowing tube 100. That is, air (in the arrow-A1 direction) discharged from the discharge tube 331 to flow in the first flow path 323a flows in the first air blowing tube 110 from the third flow path 323c (the arrow-C1 direction) due to the switching valve 325. Air flowing in the arrow-C2 direction inside the second air blowing tube 120 to flow in the fourth flow path 323d flows in the intake tube 333 from the second flow path 323b (in the arrow-A2 direction) due to the switching valve 325, returns to the blower 310, and is discharged again from the discharge tube 331.

### <<Operation of Switching Unit: Summary>>

By connecting two endless pipes (the first circulation pipe 330 and the air blowing tube 100) via the switching unit 320 as described above, three states including the neutral state in which no air flow is generated in the air blowing tube 100, the first communication state in which an air flow flowing in the first direction (the arrow-B direction) is generated inside the air blowing tube 100, and the second communication state in which an air flow flowing in the second direction (the arrow-C direction) is generated inside the air blowing tube 100 can be changed by changing the position of the switching valve 325 while an air flow in a certain direction (the arrow-A direction) is generated by the single blower 310.

In intermediate positions taken by the switching valve 325 among the three positions described above, the communication state changes from those in the three states. That is, since the communication relation among the flow paths and the opening degrees of the flow paths can be adjusted according to the angle of the switching valve 325 in the casing 321 in the present embodiment, an air volume of the air flow according to the opening degrees of the flow paths can be generated inside the air blowing tube 100. That is, the speed of the moving body 200 can be varied according to the wind speed in the air blowing tube 100.

The moving speed of the moving body 200 may be adjusted by control of the air volume of the blower 310. For example, the air volume of the blower 310 may be adjusted by varying the rotational speed of blades of the blower 310 by PWM (Pulse Width Modulation) control. However, since the rotation responsiveness of the switching valve 325 is higher than the variation responsiveness of the rotational speed of the blower 310, adjustment of the rotation angle of the switching valve 325 is more advantageous to rapidly adjust the speed of the moving body 200.

### <Transport Tube>

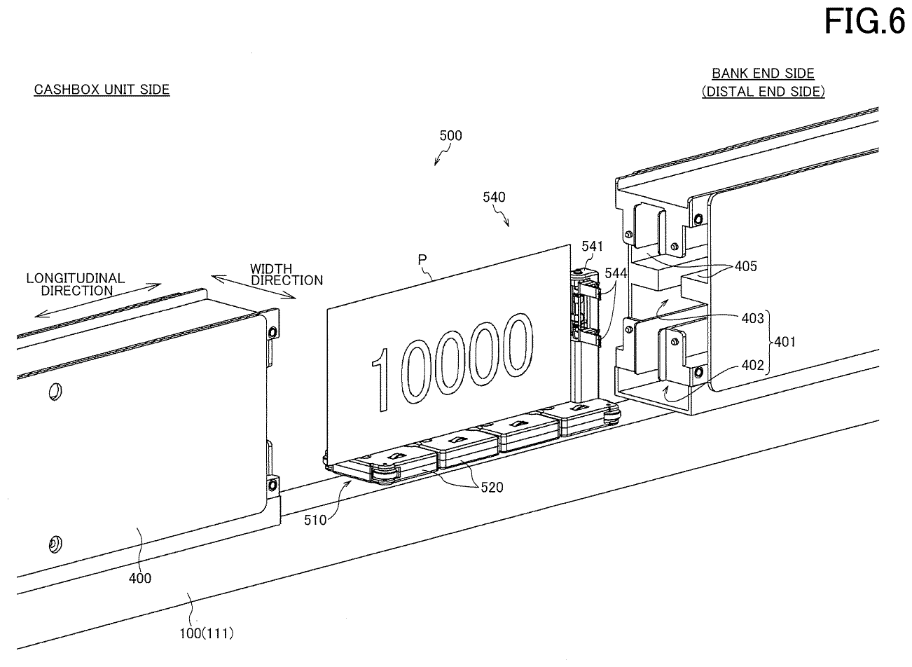

The transport tube (the transport route) 400 is explained with reference to FIGS. 4 and 6.

FIG. 6 is a perspective view illustrating a relation between the transport tube and the transport body. FIG. 6 illustrates a state in which the inner part of the transport tube 400 is partially exposed.

Since the transport body 500 is transported with a magnetic force in the banknote transport system 10, the transport tube 400 is formed of a material that does not affect the travel of the transport body 500 based on the magnetic force. Although it is desirable that the transport tube 400 is entirely formed of a non-magnetic material, the transport tube 400 may include a magnetic material in a part thereof without affecting the travel of the transport body 500.

The transport tube 400 includes a configuration (the thickness of the tube, the spacing between tubes, the shape thereof, and the like) that can apply a magnetic force between the moving body 200 arranged inside the moving route part 111 and the transport body 500 arranged inside the transport tube 400.

Although the transport tube 400 is arranged above the air blowing tube 100 in the present example, the location relation between the air blowing tube 100 and the transport tube 400 is not limited thereto. The transport tube 400 may be arranged below the air blowing tube 100 or the transport tube 400 may be arranged on the lateral side of the air blowing tube 100.

While the transport tube 400 is illustrated as means that constitutes the transport path 401 in the present example, the means that constitutes the transport path 401 does not need to be tubular and the present invention can be achieved even with a configuration in which a part or the whole of the transport path 401 is open to outside. That is, the transport tube 400 can have any form when it can form an elongated space as the transport path 401 therein.

### <Transport Body>

As illustrated in FIGS. 4 and 6, the transport body 500 includes a transport base 510 that is arranged on the side nearer the air blowing tube 100 in the transport path 401 and that is subjected to a magnetic force from the moving body 200, and a banknote collecting/retaining part 540 provided on the opposite side of the transport base 510 to the air blowing tube 100.

### <<Transport Base>>

The transport base 510 has a configuration in which a plurality of divided pieces 520, 520, . . . are sequentially coupled to each other with hinge parts 521 along the travel direction of the transport body 500 (the longitudinal direction of the transport tube 400). Each of the divided pieces 520 illustrated in the present example includes the transport body magnet 523.

The transport base 510 includes the transport body magnets 523 arranged at locations, in attitudes, and in shapes that can be subjected to the effect of the magnetic force from the moving body 200. In the present example, the transport body magnets 523 are arranged on the side of the transport base 510 nearer the air blowing tube 100. The transport body magnets 523 included in the transport base 510 are arranged spaced apart from each other in the travel direction of the transport body 500. In the present example, each of the transport body magnets 523 is attached to the associated divided piece 520 in such a manner that the N pole (one of the poles) faces the side of the air blowing tube 100 (the lower side in FIGS. 4 and 6) and the S pole (the other pole) faces the upper side in FIGS. 4 and 6. The transport base 510 magnetically levitates in the transport tube 400 under a repelling force due to the magnetic force from the moving body 200.

The transport base 510 illustrated in the present example is constituted of four divided pieces 520. The divided pieces 520 are coupled to each other to be angularly displaceable within a predetermined range in the upper-lower direction in FIGS. 4 and 6 and the depth direction of the plane of paper centering on the hinge parts 521, respectively. With the configuration described above, the transport body 500 can smoothly move in the transport tube 400 even when the transport tube 400 forms the transport path 401 curved in the upper-lower or right-left direction.

### <<Banknote Collecting/Retaining Part>>

The banknote collecting/retaining part 540 is arranged on the transport base 510. The banknote collecting/retaining part 540 includes a support member 541 that is upright in a direction away from the air blowing tube 100, and collecting members (collecting pawls) 544 that are protruded from the support member 541 in the width direction at an end portion on the bank end side in the longitudinal direction of the transport tube 400 (on the distal end side with respect to the cashbox unit 700). The support member 541 is protruded upward from a middle portion of the transport base 510 in the width direction.

The banknote collecting/retaining part 540 retains banknotes P to cause the long edge direction of the banknotes P to follow the longitudinal direction of the transport tube 400 and in an upright attitude. One of long sides (a long side positioned on the lower side in FIG. 6) of the banknote P is supported by the transport base 510. The rear end edge (one of short sides) of the banknote is supported by the support member 541 or the collecting members 544.

### <Relation Between Transport Tube and Transport Body>

The transport tube 400 includes therein a base transport path 402 arranged on the side nearer the air blowing tube 100, and a banknote transport path 403 arranged on the opposite side to the air blowing tube 100. The base transport path 402 is a horizontally-long space where the transport base 510 of the transport body 500 travels, and the banknote transport path 403 is a vertically-long space where the banknote collecting/retaining part 540 of the transport body 500 and banknotes retained by the banknote collecting/retaining part 540 travel.

Since the transport body 500 illustrated in the present example travels while being subjected to a repelling force due to a magnetic force from the moving body 200, the base transport path 402 and the transport base 510 are configured to inhibit separation (movement toward the banknote transport path 403) of the transport base 510 from the base transport path 402 and to maintain the transport base 510 at a location where the effect of the magnetic force can be received from the moving body 200.

The inner surface shape of the base transport path 402 and the outer surface shape of the transport base 510 are formed in such a manner that the transport base 510 does not relatively rotate on a virtual axis extending along the longitudinal direction of the base transport path 402 with respect to the base transport path 402. For example, the horizontal sectional shape of the base transport path 402 and the horizontal sectional shape of the transport base 510 are formed in rectangular shapes. With provision of the configuration described above, the attitude of the moving body 200 in the base transport path 402 is maintained to cause the N pole (one of the poles) of each of the transport body magnets 523 to always face the side of the air blowing tube 100.

### <Relation Between Moving Body and Transport Body>

A relation between the moving body magnetic material and the transport body magnetic material is explained.

### <<Only Repulsion>>

As illustrated in FIG. 4, one or more magnets can be arranged in both the moving body 200 and the transport body 500 in directions repelling each other to apply only the repelling force between the moving body 200 and the transport body 500. When only the repelling force is to be applied between the moving body 200 and the transport body 500, it is desirable that a plurality of magnets are arranged on at least one of the moving body 200 and the transport body 500 at a predetermined interval in the travel direction. With arrangement of the magnets in the travel direction on at least one of the moving body 200 and the transport body 500, the moving body magnets 213 and the transport body magnets 523 are alternately arrayed when the moving body 500 travels while being subjected to the repelling force from the moving body 200. That is, when the transport body 500 travels, the transport body 500 is relatively positioned with respect to the moving body 200. In this case, it is particularly preferable that the difference between the number of magnets included in the moving body 200 and the number of magnets included in the transport body 500 is one. In other words, when n is a natural number, it is preferable that n magnets are arranged on one of the moving body 200 and the transport body 500 and that n+1 magnets are arranged on the other one.

When the transport tube 400 is placed above the air blowing tube 100 and a repelling force is applied between the transport body 500 and the moving body 200, the transport body 500 levitates in the transport tube 400 and therefore the transport body 500 is less likely to be in contact with the transport tube 400. Accordingly, it is possible to prevent reduction in the transport force of the transport body 500 due to friction with the transport tube 400 and smoothly move the transport body 500. Since the contact between the transport body 500 and the transport tube 400 is suppressed, generation of fine dust (powdery dust) due to contact between members can be prevented.

When the repelling force is applied between the moving body 200 and the transport body 500, the transport force can be increased by increasing the number of magnets included in the moving body 200 and the transport body 500.

### <<Only Attraction>>

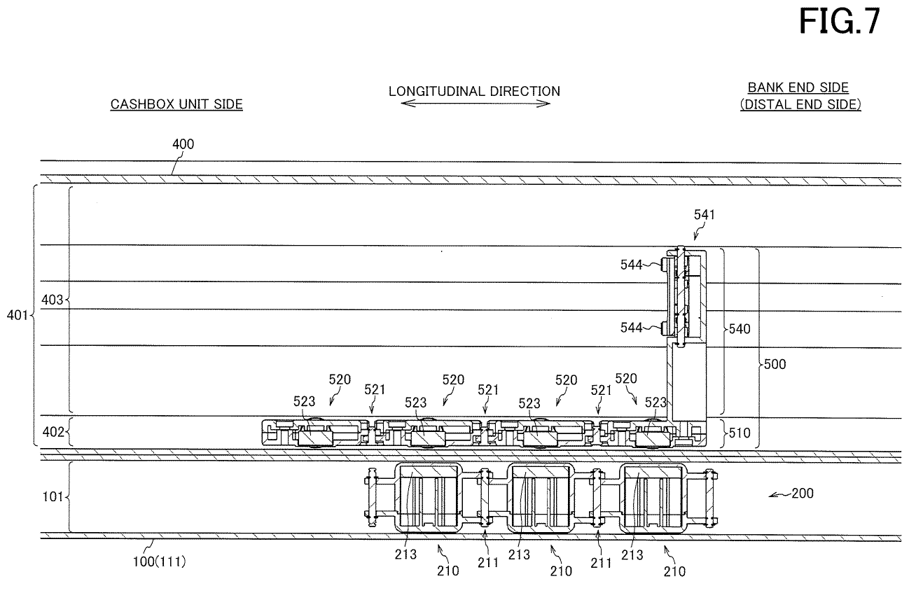

FIG. 7 is a vertical sectional view of the air blowing tube and the transport tube including the moving body and the transport body in a case in which the moving body and the transport body attract each other due to a magnetic force.

In an illustrated example, the moving body magnets 213 and the transport body magnets 523 are respectively attached to the moving body 200 and the transport body 500 in attitudes attracting each other. Since the locations in the longitudinal direction of the moving body magnets 213 and the transport body magnets 523 match each other with walls of the air blowing tube 100 and the transport tube 400 interposed therebetween, positioning of the transport body 500 with respect to the moving body 200 is easy.

When only the attracting force based on the magnetic force is to be applied between the moving body 200 and the transport body 500, it suffices that at least either the magnetic material mounted on the moving body 200 or the magnetic material mounted on the transport body 500 is a magnet. For example, magnets may be arranged on one of the transport body 500 and the moving body 200 and a magnetic material (for example, iron plates), other than magnets, that is attracted by magnets may be arranged on the other one.

When only the attracting force based on the magnetic force is to be applied between the moving body 200 and the transport body 500, it suffices that at least one set of magnetic materials (for example, a set of a magnet and a magnet or a set of a magnet and an iron plate) is arranged on the transport body 500 and the moving body 200.

### <<Repulsion and Attraction>>

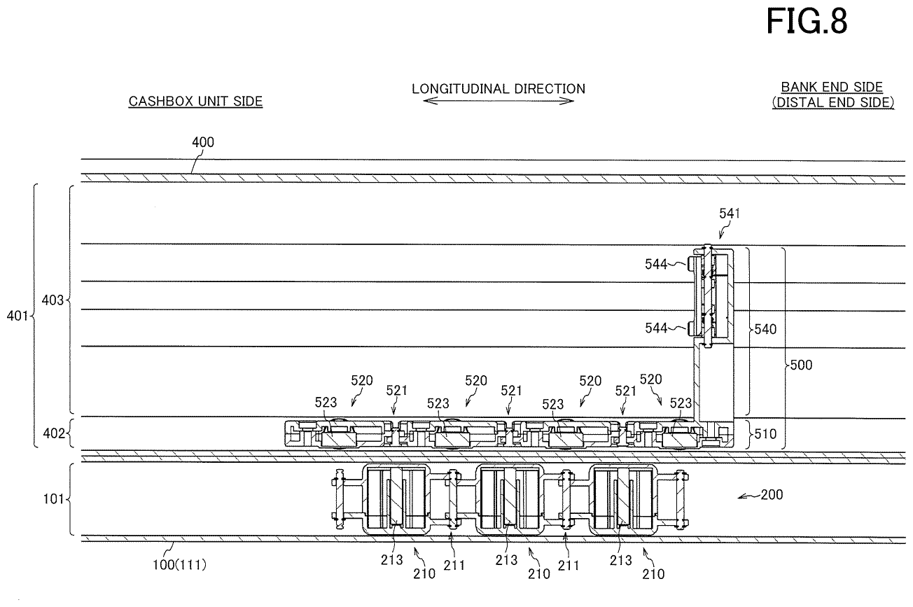

Both the repelling force and the attracting force may be applied between the moving body 200 and the transport body 500. That is, a set of magnets that apply a repelling force to each other, and a set of magnets that apply an attracting force to each other may be mixed on the moving body 200 and the transport body 500. An example in which both the repelling force and the attracting force are applied will be described later with reference to FIG. 8.

### <<Orientation of Magnets>>

While the poles of each of the magnets are arranged to face in the upper-lower direction (a staking direction of the air blowing tube 100 and the transport tube 400) in the embodiment described above, the poles of each of the magnets may be arranged to face in the travel direction (for example, to cause the N pole to face toward the cashbox unit and the S pole to face toward the bank end side/the distal end side). Alternatively, the poles of each of the magnets may be arranged diagonally to the travel direction. The action of the magnetic force can be appropriately adjusted according to the orientation of the magnets.

### <<Orientation of Magnets: Arrangement in Tandem>>

FIG. 8 is a vertical sectional view of the air blowing tube and the transport tube including the moving body and the transport body in a case in which the poles of each of the moving body magnets are arranged to face in the travel direction.

In an illustrated example, each of the moving body magnets 213 is attached to the associated divided piece 210 in such a manner that the N pole (one of the poles) faces the side of the cashbox unit (the left side in FIG. 8) and the S pole (the other pole) faces the distal end side (the right side in FIG. 8). Each of the transport body magnets 523 is attached to the associated divided piece 520 in such a manner that the N pole faces the side of the air blowing tube 100 and the S pole faces the upper side in FIG. 8.

Since surfaces (the N poles) on the cashbox unit side of the moving body magnets 213 respectively repel the transport body magnets 523 (the N poles), and the surfaces (the S poles) on the distal end side of the moving body magnets 213 respectively attract the transport body magnets 523 (the N poles), both the repelling force and the attracting force can be applied between the moving body 200 and the transport body 500.

### [First Modified Embodiment Related to Air Blow Control]

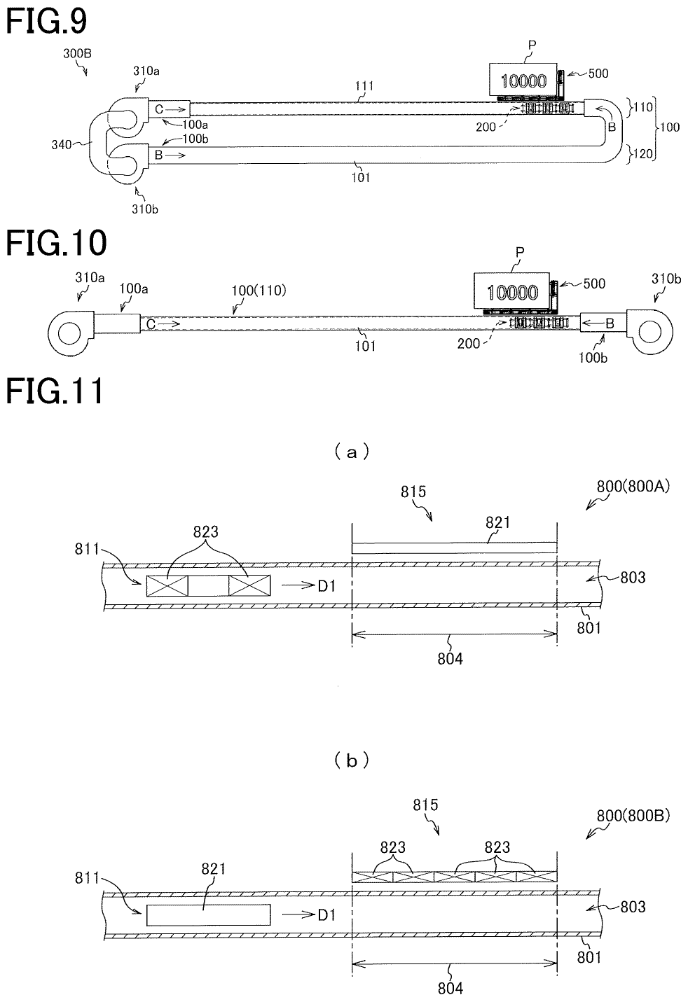

FIG. 9 is a diagram illustrating a first modification of the air-blow control unit.

An air-blow control unit 300B may have a configuration including a blower 310a having an outlet connected to one end portion 100a of the air blowing tube 100, a blower 310b having an outlet connected to the other end portion 100b of the air blowing tube 100, and a connection pipe 340 that connects inlets of the blowers 310a and 310b to each other. The air blowing tube 100 (the first air blowing tube 110 and the second air blowing tube 120) is configured in an endless manner through the two blowers 310a and 310b and the connection pipe 340.

Turning on/off of the blowers 310a and 310b and the air volume thereof are controlled by the management unit 1000.

When an air flow flowing in a first direction (an arrow-B direction) is to be generated inside the air blowing tube 100 (the first state and the banknote collecting operation state), one blower 310b is turned on to generate an air flow and the other blower 310a is turned off. Air flowing inside the air blowing tube 100 flows in the outlet of the blower 310a and is discharged from the inlet of the blower 310a. The air further passes through the connection pipe 340 to return to the inlet of the blower 310b and is discharged from the outlet of the blower 310b.

When an air flow flowing in a second direction (an arrow-C direction) is to be generated inside the air blowing tube 100 (the second state and the transport body returning state), it suffices to turn one blower 310b off and turn the other blower 310a on to generate the air flow.

In this manner, the use of two blowers also enables the air flow in the first direction and the air flow in the second direction to be generated inside the air blowing tube 100.

Since the inlets of the two blowers 310a and 310b are connected with the connection pipe 340 in the present example, air can be efficiently circulated inside the air flow path 101 airtightly configured.

### [Second Modified Embodiment Related to Air Blow Control]

FIG. 10 is a diagram illustrating a second modification of the air-blow control unit.

An air-blow control unit 300C may have a configuration including the blowers 310a and 310b at one end portion 100a and the other end portion 100b of the air blowing tube 100, respectively. Turning-on/off of the blowers 310a and 310b and the air volume thereof are controlled by the management unit 1000.

When an air flow flowing in a first direction (an arrow-B direction) is to be generated inside the air blowing tube 100 (the first state and the banknote collecting operation state), one blower 310b is turned on to generate an air flow and the other blower 310a is turned off. The blower 310b takes external air to the inside from the inlet and discharges the air, thereby generating the air flow in the arrow-B direction inside the air blowing tube 100. This air flow is taken into the blower 310a from the outlet of the blower 310a and is discharged from the inlet.

When an air flow flowing in a second direction (an arrow-C direction) is to be generated inside the air blowing tube 100 (the second state and the transport body returning state), it suffices to turn one blower 310b off and turn the other blower 310a on to generate the air flow.

Since the present example does not require pipes for causing the air flow path 101 to be a circulation path, the configuration is simplified.

### B. Deceleration Mechanism According to Second Invention

A basic configuration and an operation of a deceleration mechanism applicable to a paper sheet transport system are explained below as a second invention.

### [Basic Configuration of Deceleration Mechanism]

FIGS. 11(a) and 11(b) are schematic diagrams for explaining a basic configuration of a deceleration mechanism according to one embodiment of the present invention.

A deceleration mechanism 800 includes a traveling body 811 that is housed in a travel tube (pipe) 801 and that travels along a predetermined travel route 803 set by the travel tube 801, and braking means 815 that decelerates the traveling body 811 traveling in a deceleration section 804 set at an appropriate place on the travel route 803, in this deceleration section. The deceleration section 804 is a section in which the braking means 815 is arranged to decelerate the traveling body 811 (to cause the traveling body 811 to travel at a lower speed than in sections other than the deceleration section 804).

The traveling body 811 or the braking means 815 includes an electric conductor 821, and the braking means 815 or the traveling body 811 includes magnets 823 that generate an eddy current in the electric conductor 821. The braking means 815 is means for decelerating the traveling body 811 by an effect of electromagnetic induction. FIG. 11(a) illustrates an example in which the traveling body 811 that travels includes the magnets 823, and FIG. 11(b) illustrates an example in which the braking means 815 that is fixedly arranged or moves in a significantly limited range includes the magnets 823.

The configurations illustrated in FIG. 11 correspond to the configurations illustrated in FIGS. 3, 4, and the like as follows.

First, the traveling body 811 is the moving body 200, the travel tube 801 is the air blowing tube 100, and the travel route 803 is the air flow path 101.

Secondly, the traveling body 811 is the transport body 500, the travel tube 801 is the transport tube 400, and the travel route 803 is the transport path 401.

The inside of the travel tube 801 forming the travel route 803 may be an airtight (or liquid tight) space in which a fluid (a gas such as air or a liquid) is sealed. The traveling body 811 can travel in the travel tube 801 while receiving energy from the fluid flowing in the travel tube 801.

The traveling body 811 may be means transported on the travel route 803 on the basis of a repelling force or an attracting force acting between a magnetic material (e.g. the moving body magnets 213) moving outside the travel route 803 along the travel route 803 and a magnetic material included in the traveling body 811.

The braking means 815 is arranged inside the travel tube 801 or outside the travel tube 801 in a positional relation in which the magnets 823 generate an eddy current in the electric conductor 821. In a case in which the traveling body 811 includes the magnets 823, the magnets can function as magnets for magnetic force transport and as magnets for eddy current braking.

### <Principle of Deceleration>

FIGS. 12(a) to 12(c) are schematic diagrams for explaining the deceleration principle of the deceleration mechanism.

Each of the magnets 823 is arranged in an orientation to generate a magnetic field in a direction intersecting with the travel direction. The following explanations are made assuming that the N pole of each of the magnets 823 faces the electric conductor 821 for convenience's sake.

As illustrated in FIG. 12(a), when a magnet 823 relatively moves in an arrow-D1 direction on the electric conductor 821, magnetic field lines 831 from the magnet 823 pass through the electric conductor 821. Along with movement of the magnet 823, magnetic flux passing through the electric conductor 821 increases at the front of the magnet 823 (downstream in the moving direction D1) and the magnetic flux passing through the electric conductor 821 decreases at the back of the magnet 823 (upstream in the moving direction D1).

As illustrated in FIG. 12(b), eddy currents 834 and 836 are generated in the electric conductor 821. Eddy currents 834 and 836 generate magnetic fields 833 and 835 in a direction to prevent a change (increase or decrease) in the amount of magnetic flux.

As illustrated in FIG. 12(c), the magnetic fields 833 and 835 generated in the electric conductor 821 can be regarded as small magnets. The magnet 823 is subjected to a repelling force that interferes with movement in the direction D1, from the magnetic field 833 generated at the front in the moving direction D1, and is subjected to an attracting force to move in the opposite direction to the direction D1, from the magnetic field 835 generated at the back in the moving direction D1. As a result, braking is applied to the magnet 823 by the effect of electromagnetic induction.

By adoption of an eddy current brake using electromagnetic induction in the deceleration mechanism 800 illustrated in FIGS. 11, the traveling body 811 can be decelerated without contact of the braking means 815 with the traveling body 811.

It suffices that the deceleration mechanism 800 can provide the electromagnetic induction effect. Therefore, aluminum, copper, or the like, that is a non-magnetic material can be used as the material of the electric conductor 821. For example, the traveling body 811 or the braking means 815 can include aluminum, copper, or the like processed in the shape of a plate or the like. Even when a member being a base of the traveling body 811 or the braking means 815 is a non-conductive and non-magnetic material, the traveling body 811 or the braking means 815 can include the electric conductor 821 by a method such as attaching a foil or seal-shaped conductive material to the member as the base or applying a conductive coating material on the member as the base.

The magnets 823 may be permanent magnets or electromagnets. In a case of using electromagnets as the magnets 823, the intensity of the braking force provided by the braking means 815 can be controlled by controlling a current supplied to the electromagnets.

It suffices that the shapes, arrangement, orientations, and the like of the electric conductor 821 and the magnets 823 are those that enable the traveling body 811 to be decelerated by the effect of the electromagnetic induction.

The braking means 815 may be a separate member from the travel tube 801 or may be integrated therewith.

In a case in which the braking means 815 is a separate member from the travel tube 801, the travel tube 801 is constituted of a material that does not provide the eddy current braking action to the traveling body 811.

In a case in which the braking member 815 is integrated with the travel tube 801, a portion of the travel tube 801 in the deceleration section 804 can be constituted of the electric conductor 821 or the magnets 823. The entire portion of the travel tube 801 in the circumferential direction may be constituted of the electric conductor 821 or the magnets 823. One portion of the travel tube 801 (for example, only an upper portion of the travel tube 801 illustrated in FIG. 11) in the circumferential direction may be constituted of the electric conductor 821 or the magnets 823. The remaining portion of the travel tube 801 is constituted of a material that does not provide the eddy current braking action to the travelling body 811.

The braking means 815 may intermittently provide the braking force to the traveling body 811 in the travel direction. That is, the electric conductor 821 or the magnets 823 may be divided into a plurality of pieces in the deceleration section 804 along the travel direction of the traveling body 811.

### <Deceleration Section>

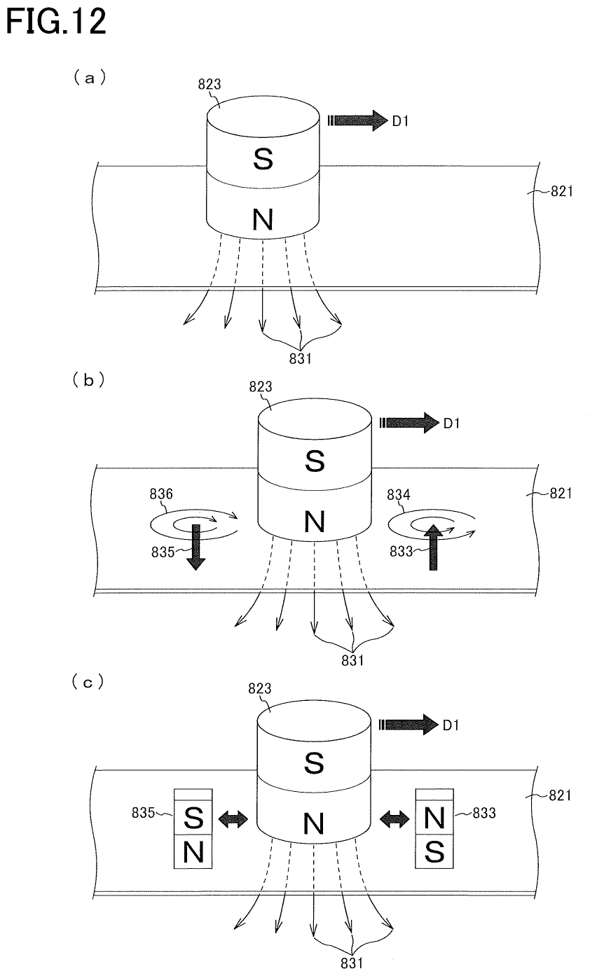

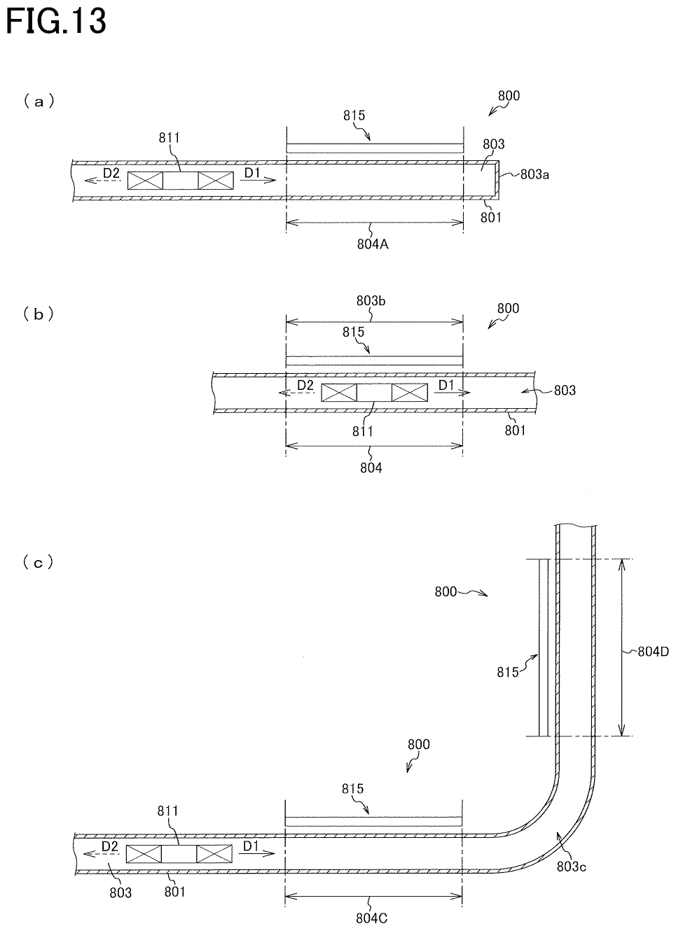

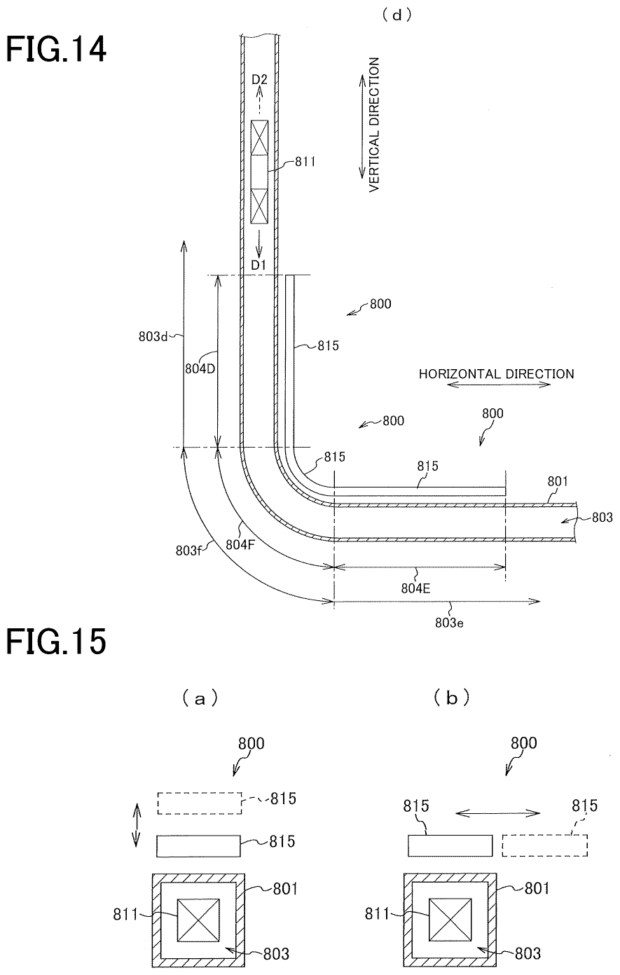

FIGS. 13(a) to 13(c) and FIG. 14(d) are schematic diagrams for explaining setting examples of the deceleration section. Examples in which the traveling body 811 travels in the arrow-D1 direction are explained below.

As illustrated in FIG. 13(a), the braking means 815 can be arranged at a position immediately before a terminal end 803a of the travel route 803 to set the corresponding portion as a deceleration section 804A. In this case, the traveling body 811 can be efficiently stopped using both decrease of traveling energy provided to the traveling body 811 and deceleration by the braking means 815.

In a case in which the deceleration mechanism 800 is installed in a device that transports objects, a receiving region 803b where delivery and receipt of a transport target is performed, or a region in a predetermined range positioned immediately before the receiving region 803b can be set as a deceleration section 804B as illustrated in FIG. 13(b). In this case, the delivery and receipt can be reliably performed without damaging the transport target.

In a case in which the travel route 803 includes a curved portion 803c that is curved as illustrated in FIG. 13(c), a deceleration section 804C can be set at a position immediately before the curved portion 803c. In this case, the entering speed at a time when the traveling body 811 enters the curved portion 803c can be decreased. The braking means 815 may be arranged in the curved portion 803c to set this portion as a deceleration section.

In a case in which the travel route 803 has a vertical portion 803d (or a high-gradient inclined portion) and a horizontal portion 803e (or a low-gradient inclined portion) as illustrated in FIG. 14(d), a deceleration section 804D can be set in the vertical portion 803d positioned immediately before the horizontal portion 803e. In this case, the entering speed at a time when the traveling body 811 enters the horizontal portion 803e can be decreased.

The braking means 815 may be arranged in the entire vertical position 803d. The braking means 815 may be arranged in a connecting portion 803f that connects the vertical portion 803d to the horizontal portion 803e to set this portion as a deceleration section 804F. A part of the horizontal portion 803e positioned on the side of the vertical portion 803d may be set as a deceleration section 804E.

In a case in which the traveling body 811 travels also in an arrow-D2 direction, the deceleration section 804 can be set similarly for the direction D2.

The deceleration section 804 in FIG. 13(b) can be set in the entire receiving region for the transport target, or a region in a predetermined range including the receiving region and regions before and after the receiving region seen from each travel direction.

Also in a case in which the travel direction is the direction D2 in FIG. 13(c), the deceleration section 804D can be set at a position immediately before the curved portion 803c seen from the direction D2. That is, the deceleration sections 804C and 804D can be set before and after the curved portion 803c seen from each travel direction.

<Switching on/Off of Deceleration Mechanism>

In a case in which the traveling body 811 moves only in one direction, the effects as described above can be obtained by setting the deceleration section 804 at least in a portion where the traveling body 811 is to be decelerated.

However, in a case in which the traveling body 811 reciprocates in the arrow-D1 direction and the arrow-D2 direction, the deceleration mechanism 800 may negatively affect the traveling body 811 moving in the direction D2 while effectively acting on the traveling body that moves in the direction D1. Examples of such case are a case in which the traveling body 811 starts moving from a vicinity of the terminal end 803a in the arrow-D2 direction in a state in which the speed is zero as in FIG. 13(a), and a case in which the traveling body 811 traveling in the horizontal portion 803e in the arrow-D2 direction enters the vertical portion 803d in FIG. 14(d). For these cases, the deceleration mechanism 800 is configured to enable the electromagnetic induction effect to be switched on and off.

FIGS. 15(a) and 15(b) are schematic diagrams illustrating examples of a method of switching the electromagnetic induction effect in the deceleration mechanism on and off.

The braking means 815 illustrated in FIGS. 15(a) and 15(b) is configured to be movable between a deceleration position (a solid line position) where the braking means 815 is close to the travel route 803 to enable deceleration of the traveling body 811 by the electromagnetic induction effect, and a non-deceleration position (a broken line position) where the braking means 815 is away from the travel route 803 to disable the deceleration of the traveling body 811 by the electromagnetic induction effect. FIG. 15(a) illustrates an example in which the braking means 815 is caused to approach or move away from the travel route 803 substantially along the magnetic flux. FIG. 15(b) illustrates an example in which the braking means 815 is moved in a direction intersecting with the magnetic flux. That is, FIG. 15(b) illustrates an example in which the braking means 815 is moved between a position where the electric conductor penetrates the magnetic flux and a position where the electric conductor does not penetrate the magnetic flux.

The deceleration mechanism 800 includes driving means that drive the braking means 815 between the deceleration position and the non-deceleration position, and control means (the management unit 1000, FIG. 3) that controls the driving means.

A solenoid, a stepping motor, or the like can be used as each driving means.

In a case in which the braking means 815 includes an electromagnet, control means (the management unit 1000, FIG. 3) that drives the electromagnet may be included, and the control means may switch the electromagnetic induction effect on and off by turning on and off power to be supplied to the electromagnet. In this case, the electromagnet acts to generate an eddy current in the electric conductor 821 to decelerate the traveling body 811 when the control means energizes the electromagnet, and acts to cause the traveling body 811 to pass the deceleration section 804 without decelerating the traveling body 811 when the control means stops energization to the electromagnet. Also in a case in which the traveling body 811 includes an electromagnet, the electromagnetic induction effect can be switched on and off by turning on and off the power to be supplied to the electromagnet. However, it is more advantageous that the braking means 815 includes an electromagnet.

The control means switches the electromagnetic induction effect on and off at an appropriate timing based on information related to the moving direction of the traveling body 811. Accordingly, the traveling body 811 can be decelerated by applying the eddy current brake to the traveling body 811 as required, or the eddy current brake is prevented from being applied to the traveling body 811 to enable the traveling body 811 to smoothly travel.

The control means can switch the electromagnetic induction effect on and off at a timing when the moving direction of the traveling body 811 is changed. The control means can determine the moving direction of the traveling body 811 on the basis of information related to the operation of the air-blow control unit 300 (FIG. 5 and the like). Alternatively, the control means can determine the moving direction of the traveling body 811 on the basis of detection outputs of a plurality of sensors arranged at appropriate places on the travel route 803.

The control means may acquire information related to the position of the traveling body 811 from detection outputs of sensors arranged at appropriate places on the travel route 803 to switch the electromagnetic induction effect on and off based on the position information. For example, when the traveling body 811 is to be decelerated in the deceleration section 804, the control means can switch the electromagnetic induction effect on at a timing before the traveling body 811 enters the deceleration section 804, and switch the electromagnetic induction effect off at a timing after the traveling body 811 passes through the deceleration section 804. Also when the traveling body 811 is not to be decelerated in the deceleration section 804, the electromagnetic induction effect can similarly be switched on or off based on the position information of the traveling body 811.

### [Application of Deceleration Mechanism to Transport System]

Configuration examples in a case in which the deceleration mechanisms 800 illustrated in FIG. 11 are applied to the banknote transport system illustrated in FIG. 3 are explained in the following embodiments. Constituent elements identical to those described above are denoted by like reference signs and explanations thereof are omitted as appropriate.

### First Embodiment

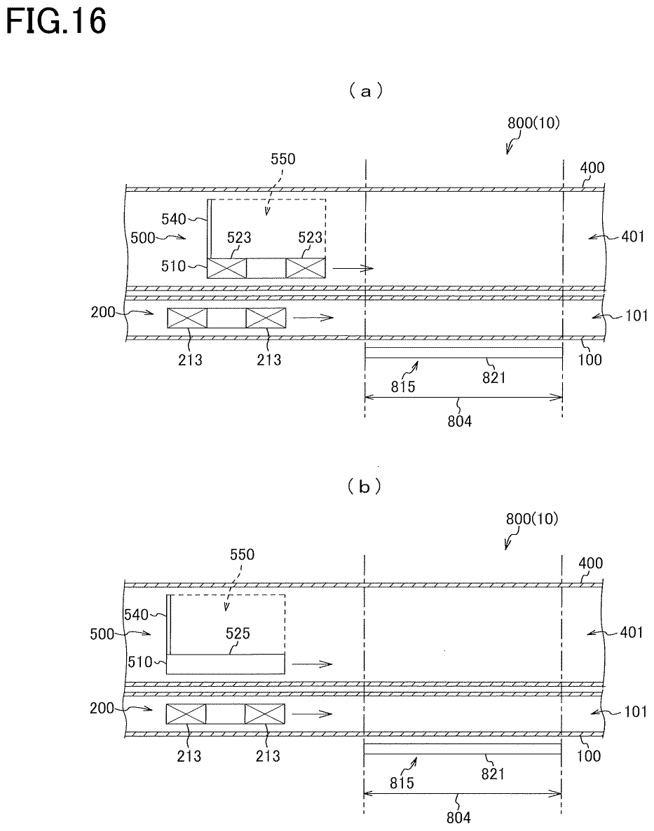

FIGS. 16(a) and 16(b) are schematic diagrams illustrating a transport system according to a first embodiment of the second invention. The present examples are examples in which magnets are arranged in the moving body and an eddy current is generated in an electric conductor included in the braking means.

The banknote transport system 10 (the deceleration mechanism 800) includes the moving body 200 that has the moving body magnets (first magnets) 213 and that moves on the air flow path (a first route) 101, the transport body 500 that has a magnetic material (the transport body magnets 523 or a transport body magnetic material 525 other than a magnet) repelling or attracting the moving body magnets 213 and that is transported on the transport path (a second route) 401 on the basis of a magnetic force acting between the moving body magnets 213 and the magnetic material, and the braking means 815 that is arranged in the deceleration section 804 of the air flow path 101 to decelerate the moving body 200. The braking means 815 includes the electric conductor 821 in which an eddy current is generated due to movement of the moving body magnets 213.

In the present examples, with provision of the moving body magnets 213 functioning as magnets for magnetic force transport and magnets constituting the deceleration mechanism, the configuration of the transport system is simplified and the number of components can be reduced.

The transport body 500 can include the transport body magnets 523 that repel the moving body magnets 213 as illustrated in FIG. 16(a). The transport body magnets 523 may be magnets that attract the moving body magnets 213. Alternatively, the transport body 500 may include a magnetic material other than a magnet, that attracts the moving body magnets 213 as illustrated in FIG. 16(b).

By the effect of electromagnetic induction, the moving body 200 is decelerated with no contact with the moving body 200 and the transport body 500 is decelerated in conjunction with the moving body 200. Therefore, the deceleration section 804 can be set at any position without changing the configurations of the air blowing tube 100 and the transport tube 400.

### Second Embodiment

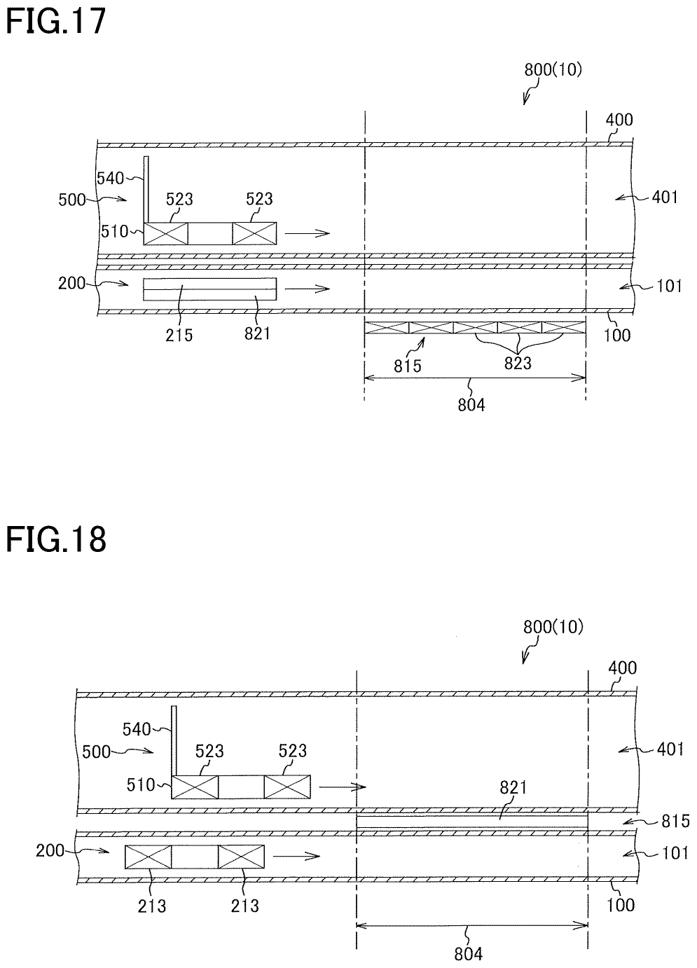

FIG. 17 is a schematic diagram illustrating a transport system according to a second embodiment of the second invention. The present example is an example in which magnets are arranged in the braking means and an eddy current is generated in an electric conductor included in the moving body.

The banknote transport system 10 (the deceleration mechanism 800) includes the moving body 200 that has a moving body magnetic material 215 and that moves on the air flow path (the first route) 101, the transport body 500 that has the transport body magnets 523 attracting the moving body magnetic material 215 and that is transported on the transport path (the second route) 401 on the basis of a magnetic force acting between the moving body magnetic material 215 and the transport body magnets 523, and the braking means 815 that is arranged in the deceleration section 804 of the air flow path 101 and that decelerates the moving body 200. The moving body magnetic material 215 is a magnetic material other than a magnet, that attracts the transport body magnets 523.

The moving body 200 includes the electric conductor 821 and the braking means 815 includes the magnets (braking magnets) 823 that generate an eddy current in the electric conductor 821 due to movement of the electric conductor 821.

In the example illustrated in FIG. 17, the moving body magnetic material 215 is arranged on the side of the transport body 500 to face the transport body 500. The electric conductor 821 is arranged on the side of the braking means 815 to face the braking means 815.

The present example is a configuration in which the braking means 815 that is fixedly arranged or moves in a limited range includes the magnets 823. Accordingly, electromagnets that require electric wiring for connecting to a power supply source are easily adopted as the magnets 823.

### Third Embodiment

FIG. 18 is a schematic diagram illustrating a transport system according to a third embodiment of the second invention. The present example is an example in which magnets are arranged in both the moving body and the transport body, and an eddy current is generated in an electric conductor included in the braking means that is arranged between the moving body and the transport body.

As illustrated in FIGS. 18, the banknote transport system 10 (the deceleration mechanism 800) includes the moving body 200 that moves on the air flow path (the first route) 101, and the transport body 500 that is transported on the transport path (the second route) 401 with a magnetic force in conjunction with movement of the moving body 200. The moving body 200 includes the moving body magnets (a first magnetic material) 213, and the transport body 500 includes the transport body magnets (a second magnetic material) 523 that repel or attract the moving body magnets 213.

The braking means 815 constituting the deceleration mechanism 800 is arranged in the deceleration section 804 that is set between the air blowing tube 100 and the transport tube 400 and in the air flow path 101 and the transport path 401. The braking means 815 includes the electric conductor 821 in which an eddy current is generated due to movement of the moving body magnets 213 and the transport body magnets 523, and decelerates both the moving body 200 and the transport body 500.

The braking means 815 illustrated in FIG. 18 includes the electric conductor 821 that is subjected to the electromagnetic induction effect from both the moving body magnets 213 and the transport body magnets 523. In this example, the braking force based on the electromagnetic induction effect can be provided also in the deceleration section 804 while the moving body magnets 213 and the transport body magnets 523 are moved in conjunction with each other using the magnetic force passing through the non-magnetic electric conductor 821.

### Fourth Embodiment

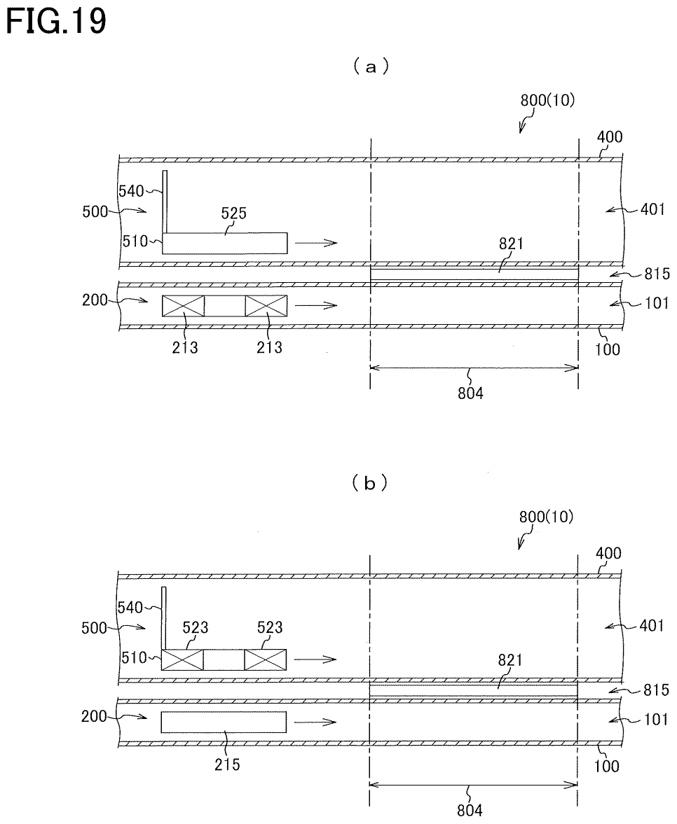

FIGS. 19(a) and 19(b) are schematic diagrams illustrating a transport system according to a fourth embodiment of the second invention. The present examples are examples in which magnets are arranged in one of the moving body and the transport body and an eddy current is generated in an electric conductor included in the braking means arranged between the moving body and the transport body.

As illustrated in FIGS. 19(a) and 19(b), the banknote transport system 10 (the deceleration mechanism 800) includes the moving body 200 that moves on the air flow path (the first route) 101, and the transport body 500 that is transported on the transport path (the second route) 401 with a magnetic force in conjunction with movement of the moving body 200.

The braking means 815 constituting the deceleration mechanism 800 is arranged in the deceleration section 804 that is set between the air blowing tube 100 and the transport tube 400 and in the air flow path 101 and transport path 401. The braking means 815 includes the electric conductor 821 in which an eddy current is generated due to movement of magnets, and decelerates the moving body 200 or the transport body 500.

As illustrated in FIG. 19(a), the moving body 200 includes the moving body magnets (the first magnetic material) 213 and the transport body 500 includes the transport body magnetic material (the second magnetic material) 525 that attracts the moving body magnets 213. The braking means 815 provides the braking force to the moving body 200 by the electromagnetic induction effect received from the moving body magnets 213.

As illustrated in FIG. 19(b), the moving body 200 includes the moving body magnetic material (the first magnetic material) 215 and the transport body 500 includes the transport body magnets (the second magnetic material) 523 that attract the moving body magnetic material 215. The braking means 815 provides the braking force to the transport body 500 by the electromagnetic induction effect received from the transport body magnets 523.

In FIGS. 19(a) and 19(b), the electric conductor 821 allows the magnetic force from the magnets 213 and 523 to pass through. Therefore, the braking force by the electromagnetic induction effect can be provided also in the deceleration section 804 while the moving body 200 and the transport body 500 are moved in conjunction with each other with the magnetic force.

Also with the present examples, the moving body 200 and the transport body 500 can be decelerated in conjunction with each other with no contact with the moving body 200 and the transport body 500.

### Fifth Embodiment

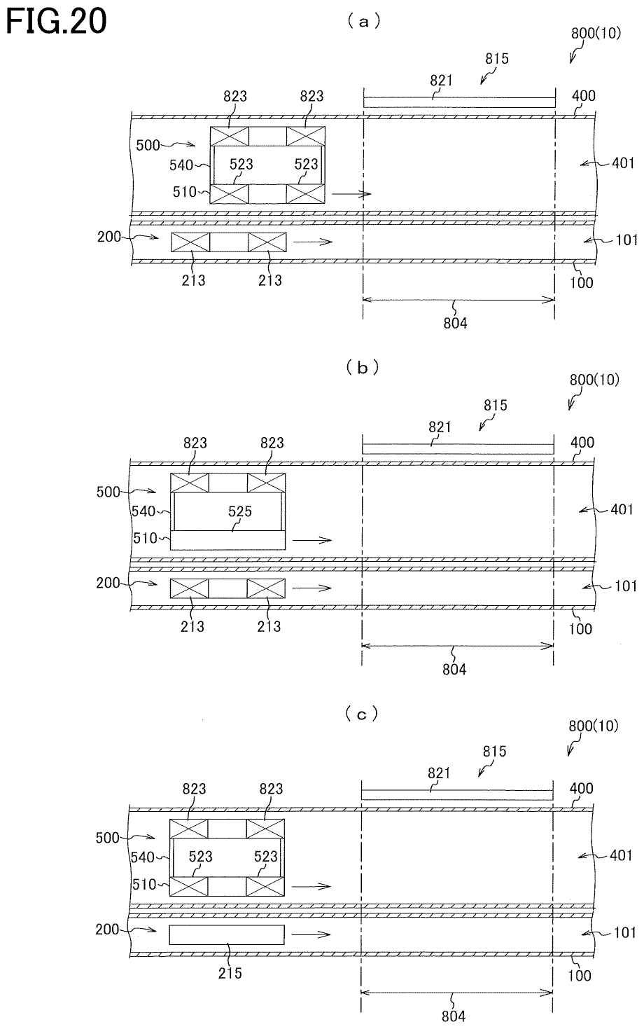

FIGS. 20(a) to 20(c) are schematic diagrams illustrating a transport system according to a fifth embodiment of the second invention. The present examples are examples in which braking magnets are arranged in the transport body and an eddy current is generated in an electric conductor included in the braking means.

The banknote transport system 10 (the deceleration mechanism 800) includes the moving body 200 that moves on the air flow path (the first route) 101, and the transport body 500 that is transported on the transport path (the second route) 401 with a magnetic force in conjunction with movement of the moving body 200. At least one of the moving body 200 and the transport body 500 includes magnets for realizing magnetic force transport using repulsion or attraction based on the magnetic force.

Specifically, the moving body 200 illustrated in FIG. 20(a) includes the moving body magnets (the first magnetic material) 213 and the transport body 500 includes the transport body magnets (the second magnetic material) 523 that repel or attract the moving body magnets 213.

The moving body 200 illustrated in FIG. 20(b) includes the moving body magnets (the first magnetic material) 213 and the transport body 500 includes the transport body magnetic material (the second magnetic material) 525 that attracts the moving body magnets 213.

The moving body 200 illustrated in FIG. 20(c) includes the moving body magnetic material (the first magnetic material) 215 and the transport body 500 includes the transport body magnets (the second magnetic material) 523 that attract the moving body magnetic material 215.

The transport body 500 illustrated in each drawing includes the braking magnets 823 constituting the deceleration mechanism 800 in addition to the second magnetic material for magnetic force transport.

The deceleration mechanism 800 includes the braking means 815 that is arranged in the deceleration section 804 of the transport path 401 to decelerate the transport body 500, and the braking means 815 includes the electric conductor 821 in which an eddy current is generated due to movement of the magnets 823.

The banknote transport system 10 described in the present examples includes the magnets 823 dedicated for the deceleration mechanism 800, and the electric conductor 821. The magnets 823 and the electric conductor 821 can be arranged at positions that are not subjected to influences of the magnetic forces of the first and second magnetic materials. Accordingly, the transport force based on the magnetic force and the braking force based on electromagnetic induction are easily individually adjusted.

### Sixth Embodiment

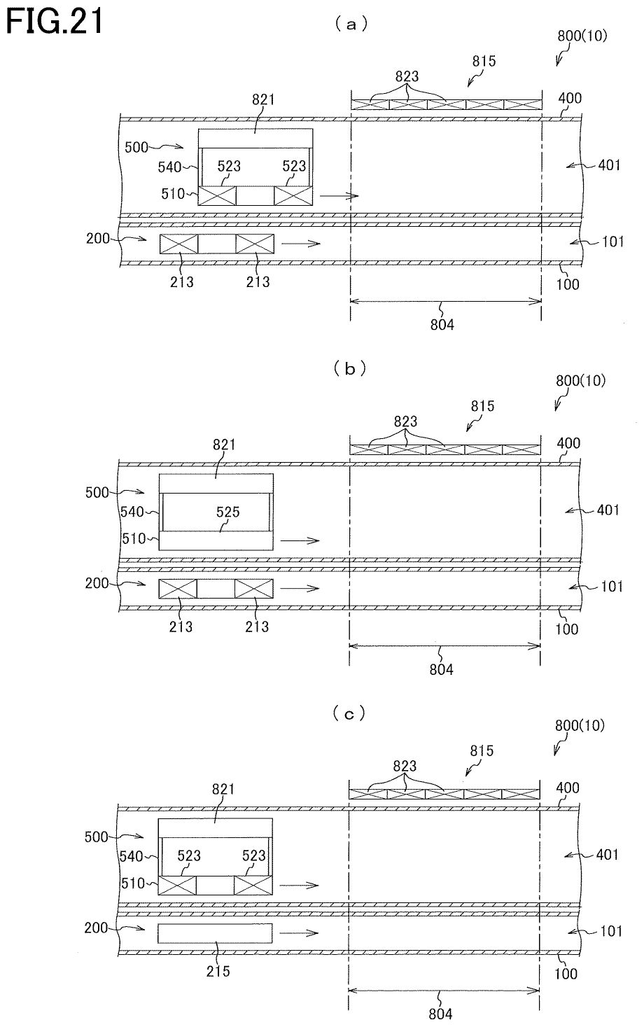

FIGS. 21(a) to 21(c) are schematic diagrams illustrating a transport system according to a sixth embodiment of the second invention. The present examples are examples in which magnets are arranged in the braking means and an eddy current is generated in an electric conductor included in the transport body.

The banknote transport system 10 (the deceleration mechanism 800) includes the moving body 200 that moves on the air flow path (the first route) 101, and the transport body 500 that is transported on the transport path (the second route) 401 with a magnetic force in conjunction with movement of the moving body 200. At least one of the moving body 200 and the transport body 500 includes magnets for realizing magnetic force transport using repulsion or attraction based on the magnetic force. Configurations of the magnetic force transport are identical to those in FIG. 20 and therefore explanations thereof are omitted.

The transport body 500 illustrated in each drawing includes the electric conductor 821 constituting the deceleration mechanism 800.

The deceleration mechanism 800 includes the braking means 815 that is arranged in the deceleration section 804 of the transport path 401 to decelerate the transport body 500, and the braking means 815 includes the magnets 823 that generate an eddy current in the electric conductor 821 that moves.

The banknote transport system 10 described in the present examples also includes the magnets 823 dedicated for the deceleration mechanism 800, and the electric conductor 821. The magnets 823 and the electric conductor 821 can be arranged at positions that are not subjected to influences of the magnetic forces of the first and second magnetic materials. Accordingly, the transport force based on the magnetic force and the braking force based on electromagnetic induction are easily individually adjusted.

### [Modification]

In the embodiments described above, the banknote transport system 10 has been described as transporting paper sheets. However, objects transported by the banknote transport system 10 are not limited to paper sheets. As one example, it suffices that the transport body 500 has a configuration in which objects as transport targets can be retained by a transport target retaining part 550 that is supported by the transport base 510 as illustrated in FIG. 16.

In the banknote transport system 10, the transport body 500 travels in the transport tube 400 isolated from the external space. Accordingly, the present transport system is suitable as a device that transports transport targets that are desired to be transported without human intervention in terms of safety or other objectives.

In the banknote transport system 10, the moving speed of the moving body 200 can be controlled by controlling the wind speed in the air blowing tube 100 with the air-blow control unit 300 (FIG. 3 and the like). However, by setting of the deceleration section 804 at an appropriate place on the air flow path 101 or the transport path 401, the moving body 200 and the transport body 500 can be decelerated without depending on the air blow control. With deceleration of the moving body 200 and the transport body 500 in a section where the speeds thereof are to be decreased, occurrence of transport jam can be prevented and smooth transport can be realized. When a transport target is transported at a high speed in parts other than the deceleration section 804 and the transport target is transported at a decreased speed in the deceleration section 804, the transport time of the transport target on the entire transport route can be reduced.

Only with the air blow control, reduction in the speed of the moving body 200 is limited. However, setting of the deceleration section 804 realizes a low-speed travel of the moving body 200 that cannot be realized only with the air blow control.

### [Summary of Exemplary Aspects, Actions, and Effects of Present Invention]

### <First Aspect>

The deceleration mechanism 800 according the present aspect includes the traveling body 811 that travels on a predetermined route (the travel route 308), and the braking means 815 that decelerates the traveling body traveling in the deceleration section 804 set in the route, in the section, one of the traveling body and the braking means includes the electric conductor 821, and the other of the traveling body and the braking means includes the magnets 823 that generate an eddy current in the electric conductor.

According to the present aspect, the traveling body can be decelerated in the deceleration section with a simple configuration.

### <Second Aspect>

The deceleration mechanism 800 according to the present aspect includes a pipe (the travel tube 801) that is airtightly configured and that forms the route (the travel route 803) therein, and a fluid flowing in the pipe, and the traveling body 811 is means that travels inside the pipe while receiving energy from the fluid flowing in the pipe.

By changing of the speed of the fluid flowing in the pipe airtightly (or liquid tightly) configured, the speed of the traveling body traveling in the pipe can be controlled. However, to control the flow speed in accordance with a timing when the traveling body passes the deceleration section, a sensor that detects the position of the traveling body is required. When there are many deceleration sections in the route, there is a risk that the control is complicated.

According to the present aspect, the traveling body can be decelerated in a deceleration section with a simple configuration without control of the flow speed.

In the present aspect, the braking means may be arranged in the pipe, the braking means may be arranged outside the pipe, or the braking means itself may constitute the pipe. In a case in which the braking means is arranged outside the pipe, the fluid is not brought to contact with the braking means. Therefore, the braking means is not adversely affected by contact with the fluid and the outer shape of the braking means does not affect the flow of the fluid. In the case in which the braking means is arranged outside the pipe, a change of the pipe configuration is not required, and setting and canceling of the deceleration section are easy.

### <Third Aspect>

In the deceleration mechanism 800 according to the present aspect, the traveling body 811 includes the magnet (the transport body magnets 523), and the braking means 815 includes the electric conductor 821, and the traveling body travels on the route on the basis of a repelling force or an attracting force acting between a magnetic material (e.g. the moving body magnets 213) moving along the route (the travel route 803) outside (the air flow path 101) the route, and the magnet.

The traveling body is transported with a magnetic force acting between the traveling body and the magnetic material moving outside the route, in conjunction with this magnetic material (magnetic force transport). In a case in which the traveling body includes a magnet, this magnet can be used for magnetic force transport in which the traveling body is caused to travel based on the magnetic force, and is enabled to function as means for generating an eddy current in an electric conductor. Therefore, the overall configuration of a transport system including the deceleration mechanism can be simplified.

### <Fourth Aspect>

In the deceleration mechanism 800 according to the present aspect, the braking means 815 is configured to be movable between a deceleration position where the braking means is close to the route (the travel route 803) to enable deceleration of the traveling body 811 due to the eddy current, and a non-deceleration position where the braking means is away from the route to disable deceleration of the traveling body due to the eddy current.

In a case in which the traveling body reciprocates on the route, while the deceleration section 804 set in the route effectively acts on the traveling body in an outward direction, the deceleration section 804 sometimes adversely affects travel of the traveling body in a return direction.

In the present aspect, an eddy-current braking function is switched on and off by moving the braking means between the deceleration position and the non-deceleration position. Accordingly, the traveling body can be decelerated in the deceleration section or the traveling body can be caused to pass through the deceleration section without being decelerated.

### <Fifth Aspect>

In the deceleration mechanism 800 according to the present aspect, the traveling body 811 includes the electric conductor 821 and the braking means 815 includes an electromagnet as the magnet 823, and the electromagnet is configured to be switchable between a conduction state in which the traveling body is decelerated by the eddy current and a non-conduction state in which the traveling body is not decelerated.

In a case in which the traveling body reciprocates on a route, while the deceleration section 804 set in the route effectively acts on the traveling body in an outward direction, the deceleration section 804 sometimes adversely affects travel of the traveling body in a return direction.

According to the present aspect, the eddy-current braking function is switched on or off by energizing the electromagnet or stopping the energization. Accordingly, the traveling body can be decelerated in the deceleration section or the traveling body can be caused to pass through the deceleration section without being decelerated.

In a case in which an electromagnet is used as the magnet of the deceleration mechanism, the braking force can be controlled. The electromagnet needs to be connected to a power supply source. Therefore, in a case in which an electromagnet is adopted in the deceleration mechanism, it is preferred that the electromagnet is included in the braking means that is fixedly arranged or moves in a limited range.

### <Sixth Aspect>

The deceleration mechanism 800 (FIG. 16) according to the present aspect includes the moving body 200 that has a first magnet (the moving body magnets 213) and that moves on a first route (the air flow path 101), the transport body 500 that has a magnetic material (the transport body magnets 523 or the transport body magnetic material 525) repelling or attracting the first magnet and that is transported on a second route (the transport path 401) on the basis of a magnetic force acting between the first magnet and the magnetic material, and the braking means 815 that is arranged in the deceleration section 804 on the first route and that decelerates the moving body, and the braking means includes the electric conductor 821 in which an eddy current is generated due to movement of the first magnet.

In the present aspect, the transport body is transported with a magnetic force in conjunction with the moving body.

According to the present aspect, the moving body and the transport body can be decelerated in a deceleration section with a simple configuration. Since an eddy current is generated in the electric conductor being the braking means using the first magnet that magnetically transports the transport body, the overall configuration of a transport system including the deceleration mechanism can be simplified.

### <Seventh Aspect>

The deceleration mechanism 800 (FIG. 17) according to the present aspect includes the moving body 200 that has a magnetic material (the moving body magnetic material 215) and that moves on a first route (the air flow path 101), the transport body 500 that has a magnet (the transport body magnets 523) attracting the magnetic material and that is transported on a second route (the transport path 401) on the basis of a magnetic force acting between the magnetic material and the magnet, and the braking means 815 that is arranged in the deceleration section 804 on the first route and that decelerates the moving body, the moving body includes the electric conductor 821, and the braking means includes the braking magnets 823 that generate an eddy current in the electric conductor due to movement of the electric conductor.

In the present aspect, the transport body is transported with a magnetic force in conjunction with the moving body.

According to the present aspect, the moving body and the transport body can be decelerated in a deceleration section with a simple configuration.

### <Eighth Aspect>

The deceleration mechanism 800 (FIG. 18 or 19) according to the present aspect includes the moving body 200 that has a first magnetic material (the moving body magnets 213 or the moving body magnetic material 215) and that moves on a first route (the air flow path 101), the transport body 500 that has a second magnetic material (the transport body magnets 523 or the transport body magnetic material 525) repelling or attracting the first magnetic material and that is transported on a second route (the transport path 401) on the basis of a magnetic force acting between the first magnetic material and the second magnetic material, and the braking means 815 that is arranged in the deceleration section 804 located between the first route and the second route and in the first route and the second route and that decelerates the moving body or the transport body, at least one of the first magnetic material and the second magnetic material is a magnet, and the braking means includes the electric conductor 821 in which an eddy current is generated due to movement of the magnet.

In the present aspect, the transport body is transported with a magnetic force in conjunction with the moving body. In the present aspect, the braking means is arranged between the moving body and the transport body, and the magnet arranged in at least one of the moving body and the transport body generates an eddy current in the electric conductor.

According to the present aspect, the traveling body can be decelerated in a deceleration section with a simple configuration. Furthermore, since an eddy current is generated in the electric conductor being the braking means using the magnet for magnetically transporting the transport body, the overall configuration of a transport system including the deceleration mechanism can be simplified.

### <Ninth Aspect>

The deceleration mechanism 800 (FIG. 18) according to the present aspect includes the moving body 200 that has a first magnet (the moving body magnets 213) and that moves on a first route (the air flow path 101), the transport body 500 that has a second magnet (the transport body magnets 523) repelling or attracting the first magnet and that is transported on a second route (the transport path 401) on the basis of a magnetic force acting between the first magnet and the second magnet, and the braking means 815 that is arranged in the deceleration section 804 located between the first route and the second route and in the first route and the second route and that decelerates the moving body and the transport body, and the braking means includes the electric conductor 821 in which an eddy current is generated due to movement of the first magnet and the second magnet.

In the present aspect, the transport body is transported with a magnetic force in conjunction with the moving body. In the present aspect, the braking means is arranged between the moving body and the transport body, and the magnets arranged in both the moving body and the transport body generate an eddy current in the electric conductor.

According to the present aspect, the traveling body can be decelerated in a deceleration section with a simple configuration. Furthermore, since an eddy current is generated in the electric conductor being the braking means using the magnet for magnetically transporting the transport body, the overall configuration of a transport system including the deceleration mechanism can be simplified.

### <Tenth Aspect>

The deceleration mechanism 800 (FIG. 20 or 21) according to the present aspect includes the moving body 200 that has a first magnetic material (the moving body magnets 213 or the moving body magnetic material 215) and that moves on a first route (the air flow path 101), the transport body 500 that has a second magnetic material (the transport body magnets 523 or the transport body magnetic material 525) repelling or attracting the first magnetic material and that is transported on a second route (the transport path 401) on the basis of a magnetic force acting between the first magnetic material and the second magnetic material, and the braking means 815 that is arranged in the deceleration section 804 in the second route and that decelerates the transport body, one of the transport body and the braking means includes the electric conductor 821, and the other of the transport body and the braking means includes the braking magnet 823 that generates an eddy current in the electric conductor.

In the present aspect, the transport body is transported with a magnetic force in conjunction with the moving body.

According to the present aspect, the moving body and the transport body can be decelerated in a deceleration section with a simple configuration.

### <Eleventh Aspect>

The deceleration mechanism 800 according to the present aspect includes a pipe (the air blowing tube 100) that forms the first route (the air flow path 101), and a fluid (air) that flows in the pipe, and the moving body 200 is means that travels in the pipe while receiving energy from the fluid flowing in the pipe.

According to the present aspect, the moving body and the transport body can be decelerated in a deceleration section with a simple configuration without control of the flow speed.

### REFERENCE SIGNS LIST

L . . . bank facility, 1 . . . game machine, 2 . . . sandwiched machine, 10 . . . banknote transport system, 100 . . . air blowing tube (pipe), 101 . . . air flow path (first route), 110 . . . first air blowing tube, 111 . . . moving route part, 120 . . . second air blowing tube, 200 . . . moving body, 210 . . . divided piece, 211 . . . hinge part, 213 . . . moving body magnet (first magnet, first magnetic material), 215 . . . moving body magnetic material (first magnetic material), 300 . . . air-blow control unit, 310 . . . blower, 320 . . . switching unit, 321 . . . casing, 323 . . . flow path, 325 . . . switching valve, 330 . . . first circulation pipe, 330a . . . one end portion, 330b . . . the other end portion, 331 . . . air discharge tube, 333 . . . air intake tube, 340 . . . connection pipe, 400 . . . transport tube (pipe), 401 . . . transport path (second route), 402 . . . base transport path, 403 . . . banknote transport path, 500 . . . transport body, 510 . . . transport base, 520 . . . divided piece, 521 . . . hinge part, 523 . . . transport body magnet (second magnet, second magnetic material), 525 . . . transport body magnetic material (second magnetic material), 540 . . . banknote collecting/retaining part, 541 . . . support member, 544 . . . collecting member, 550 . . . transport target retaining part, 600 . . . receiving unit, 700 . . . cashbox unit, 800 . . . deceleration mechanism, 801 . . . travel tube (pipe), 803 . . . travel route, 803a . . . terminal end, 803b . . . receiving region, 803c . . . curved portion, 803d . . . vertical portion, 803e . . . horizontal portion, 803f . . . connecting portion, 804, 804A to 804F . . . deceleration section, 811 . . . traveling body, 815 . . . braking means, 821 . . . electric conductor, 823 . . . magnet (braking magnet), 831 . . . magnetic field line, 833, 835 . . . magnetic field, 834, 836 . . . eddy current, 1000 . . . management unit, 1001 . . . housing

1. A deceleration mechanism comprising:
a traveling body that travels on a predetermined route; and
braking means that decelerates the traveling body in a deceleration section set in the route,
wherein the traveling body or the braking means includes an electric conductor, and
wherein the braking means or the traveling body includes a magnet that generates an eddy current in the electric conductor.

2. The deceleration mechanism according to claim 1, further comprising:
a pipe that is airtightly configured and that forms the route therein, and
a fluid flowing in the pipe,
wherein the traveling body is means that travels inside the pipe while receiving energy from the fluid flowing in the pipe.

3. The deceleration mechanism according to claim 1, wherein the traveling body includes the magnet, and the braking means includes the electric conductor, and
wherein the traveling body travels on the route on a basis of a repelling force or an attracting force acting between a magnetic material moving along the route outside the route, and the magnet.

4. The deceleration mechanism according to claim 2, wherein the braking means is configured to be movable between a deceleration position where the braking means is close to the route to enable deceleration of the traveling body due to the eddy current, and a non-deceleration position where the braking means is away from the route to disable deceleration of the traveling body due to the eddy current.

5. The deceleration mechanism according to claim 2, wherein the traveling body includes the electric conductor and the braking means includes an electromagnet as the magnet, and
wherein the electromagnet is configured to be switchable between a conduction state in which the traveling body is decelerated by the eddy current and a non-conduction state in which the traveling body is not decelerated.

6. A deceleration mechanism comprising:
a moving body that has a first magnet and that moves on a first route;
a transport body that has a magnetic material repelling or attracting the first magnet and that is transported on a second route on a basis of a magnetic force acting between the first magnet and the magnetic material; and
braking means that is arranged in a deceleration section on the first route and that decelerates the moving body,
wherein the braking means includes an electric conductor in which an eddy current is generated due to movement of the first magnet.

7. A deceleration mechanism comprising:
a moving body that has a magnetic material and that moves on a first route;
a transport body that has a magnet attracting the magnetic material and that is transported on a second route on a basis of a magnetic force acting between the magnetic material and the magnet; and
braking means that is arranged in a deceleration section on the first route and that decelerates the moving body,
wherein the moving body includes an electric conductor, and
wherein the braking means includes a braking magnet that generates an eddy current in the electric conductor due to movement of the electric conductor.

8. A deceleration mechanism comprising:
a moving body that has a first magnetic material and that moves on a first route;
a transport body that has a second magnetic material repelling or attracting the first magnetic material and that is transported on a second route on a basis of a magnetic force acting between the first magnetic material and the second magnetic material; and
braking means that is arranged in a deceleration section located between the first route and the second route and in the first route and the second route and that decelerates the moving body or the transport body,
wherein at least one of the first magnetic material and the second magnetic material is a magnet, and
wherein the braking means includes an electric conductor in which an eddy current is generated due to movement of the magnet.

9. A deceleration mechanism comprising:
a moving body that has a first magnet and that moves on a first route;
a transport body that has a second magnet repelling or attracting the first magnet and that is transported on a second route on a basis of a magnetic force acting between the first magnet and the second magnet; and
braking means that is arranged in a deceleration section located between the first route and the second route and in the first route and the second route and that decelerates the moving body and the transport body,
wherein the braking means includes an electric conductor in which an eddy current is generated due to movement of the first magnet and the second magnet.

10. A deceleration mechanism comprising:
a moving body that has a first magnetic material and that moves on a first route;
a transport body that has a second magnetic material repelling or attracting the first magnetic material and that is transported on a second route on a basis of a magnetic force acting between the first magnetic material and the second magnetic material; and
braking means that is arranged in a deceleration section in the second route and that decelerates the transport body,
wherein the transport body or the braking means includes an electric conductor, and
wherein the braking means or the transport body includes a braking magnet that generates an eddy current in the electric conductor.

11. The deceleration mechanism according to claim 6, further comprising:
a pipe that forms the first route, and
a fluid that flows in the pipe,
wherein the moving body is means that travels in the pipe while receiving energy from the fluid flowing in the pipe.

12. The deceleration mechanism according to claim 3, wherein the braking means is configured to be movable between a deceleration position where the braking means is close to the route to enable deceleration of the traveling body due to the eddy current, and a non-deceleration position where the braking means is away from the route to disable deceleration of the traveling body due to the eddy current.

13. The deceleration mechanism according to claim 3, wherein the traveling body includes the electric conductor and the braking means includes an electromagnet as the magnet, and
wherein the electromagnet is configured to be switchable between a conduction state in which the traveling body is decelerated by the eddy current and a non-conduction state in which the traveling body is not decelerated.

14. The deceleration mechanism according to claim 7, further comprising:
a pipe that forms the first route, and
a fluid that flows in the pipe,
wherein the moving body is means that travels in the pipe while receiving energy from the fluid flowing in the pipe.

15. The deceleration mechanism according to claim 8, further comprising:
a pipe that forms the first route, and
a fluid that flows in the pipe,
wherein the moving body is means that travels in the pipe while receiving energy from the fluid flowing in the pipe.

16. The deceleration mechanism according to claim 9, further comprising:
a pipe that forms the first route, and
a fluid that flows in the pipe,
wherein the moving body is means that travels in the pipe while receiving energy from the fluid flowing in the pipe.

17. The deceleration mechanism according to claim 10, further comprising:
a pipe that forms the first route, and
a fluid that flows in the pipe,
wherein the moving body is means that travels in the pipe while receiving energy from the fluid flowing in the pipe.
